(19) United States
(12) Patent Application Publication
(10) Pub. No.: US 2023/0341321 A1
(43) Pub. Date: Oct. 26, 2023

(54) SENSOR ARRANGEMENT AND METHOD FOR DETERMINING A CO2 CONTENT IN A GIVEN ENVIRONMENT

(71) Applicant: OSRAM Opto Semiconductors GmbH, Regensburg (DE)

(72) Inventor: Herbert KAESTLE, Traunstein (DE)

(21) Appl. No.: 17/791,552

(22) PCT Filed: Jan. 8, 2021
(86) PCT No.: PCT/EP2021/050248

§ 371 Date: Jul. 8, 2022

(30) Foreign Application Priority Data
Jan. 9, 2020 (DE) 10 2020 200 187.1

(51) Int. Cl. G01N 21/3504

(52) U.S. Cl. CPC G01N 21/3504

(57) ABSTRACT

In various embodiments, a sensor arrangement for sensing an absolute CO₂ level in a given environment may include a light source, an absorption path, a light detector, and an amplifier. The absorption path may be configured to communicate with the given environment, arranged such that a light beam passes through the absorption path, and may have a length ranging from 5 mm to 20 mm. The light detector may be arranged to detect the light beam configured to emerge from the absorption path. The light detector may produce an output signal corresponding to a measured value for the absolute CO₂ content in the given environment. The amplifier may be electrically coupled to the light detector and configured to have an output signal corresponding to the absolute CO₂ content in the given environment.

### CROSS-REFERENCE TO RELATED APPLICATIONS

The present application is a national stage entry according to 35 U.S.C. § 371 of PCT application No.: PCT/EP2021/050248 filed on Jan. 8, 2021; which claims priority to German patent application DE 10 2020 200 187.1, filed on Jan. 9, 2020; all of which are incorporated herein by reference in their entirety and for all purposes.

### TECHNICAL FIELD

The disclosure relates to a sensor arrangement and a method for determining a CO₂ level in a given environment.

### BACKGROUND

The determination and/or monitoring of CO₂ levels in a given environment, for example in the air of a room or building, can be important in the field of real-estate management, air quality monitoring and/or air conditioning control, for example.

In a conventional sensor arrangement for determining an absolute CO₂ content in a given environment, the CO₂ content can be determined based on an analysis of the infrared absorption along a given optical path. Furthermore, sensor arrangements are known in which the chemical potential of the CO₂ at a catalytic working electrode is evaluated to determine the CO₂ content.

In the case of determining the CO₂ content by means of infrared absorption, a CO₂ sensor can, for example, be based on the direct non-dispersive absorption spectroscopy technique (NDIR). In this technique, a light beam, in particular an infrared light beam, is sent through an absorption path that communicates with the environment and is subsequently detected by a light detector of suitable sensitivity. The light beam can be generated, for example, by means of an LED, for example a laser diode and/or an infrared LED. In order for the absorption path to communicate with the environment, there must be free air and/or gas exchange between the absorption path and the environment. For example, the absorption section is open to the environment.

FIG. 1 shows a diagram in which an absorption intensity in cm/mol (Y-axis) is plotted as a function of the wavelength of the light beam (X-axis). It can be seen from the diagram that the strongest absorption of CO₂ occurs between 4.2 μm and 4.3 μm. In this range, there is little interference with other components of air or other gases, such as water (H₂O) or methane (CH₄). Therefore, this range is particularly suitable for detecting the CO₂ content in the environment. Another very wide absorption range extends in a region around 15 μm. However, this range is not so well suited for detecting the CO₂ content because on the one hand, suitable light sources and light detectors are expensive in this wavelength range and, on the other hand, because there is basically strong background radiation in this range, the effects of which are difficult or impossible to prevent and which falsifies the desired measurement signal.

Since light absorption in the wavelength range between 4.2 μm and 4.3 μm is essentially determined by the CO₂ content, the intensity of a light beam to be detected after passing through the absorption section in this wavelength range is a good measure of the relative CO₂ content in the corresponding environment. Therefore, the corresponding light beam may be generated with a wavelength between 3.8 μm and 4.3 μm, for example between 4.2 μm and 4.3 μm, for example at 4.23 μm. This wavelength range is also referred to as the Mid-Infrared Region (MIR). A light detector that is also sensitive in the mid-infrared region is used as the light detector. Subsequently, the relative CO₂ concentration can be determined in accordance with Lambert-Beer's law.

Such sensor arrangements regularly use relatively strong light sources, such as laser diodes, to generate the light beam and relatively long absorption distances in the range of a few to several centimeters to achieve a measurement result with sufficiently good accuracy. However, laser diodes are relatively expensive and the long absorption paths require a relatively large amount of space, which is poorly or not at all acceptable for a portable sensor arrangement, for example one that is integrated into a portable electronic device.

### SUMMARY

One object of the disclosure is to provide a sensor arrangement for detecting a CO₂ content in a given environment, which can be produced simply and/or inexpensively and/or which enables the CO₂ content to be determined particularly accurately.

One object of the disclosure is to provide a method for detecting a CO₂ content in a given environment, which is easy and/or inexpensive to carry out and/or which enables a particularly accurate determination of the CO₂ content.

A problem of the disclosure is solved by a sensor arrangement for detecting an absolute CO₂ content in a given environment, comprising:
a light source for generating a light beam;
an absorption path communicating with the given environment, arranged so that the light beam passes through the absorption path, and having a length between 5 mm and 20 mm;
a light detector arranged to detect the light beam emerging from the absorption path and arranged to produce an output signal representative of a measurement value representative of the absolute CO₂ content in the given environment; and an amplifier electrically coupled to the light detector and arranged to have its output signal representative of the absolute CO₂ content in the given environment.

The relatively short absorption distance between 5 mm and 20 mm makes it possible to design the sensor arrangement to be portable and/or to integrate the sensor arrangement into a portable device. Such a portable device can be, for example, a cell phone, a tablet or a laptop. The determination of the absolute CO₂ content helps to ensure that the CO₂ content can be determined with sufficient accuracy despite the short absorption distance.

A simple MIR LED can be used as the light source, which is usually relatively inexpensive compared to a laser diode. Similarly, a simple MIR photodiode can be used as the light detector. This helps to make the sensor arrangement particularly inexpensive to manufacture.

In other words, one aspect relates to a measurement arrangement in which the CO₂ content in a space can be determined on the basis of IR absorption, whereby the length of the absorption path is optimally designed with respect to the characteristics of low-cost IR light sources as well as low-cost IR measurement sensors and the electronic signal conditioning technology matched thereto.

The object is also solved, among other things, by a sensor arrangement for detecting a CO₂ content in a given environment according to claim 1.

In one aspect, a sensor arrangement comprises at least one controlled light source for generating a pulsed light beam. An absorption path in communication with the given environment is arranged such that the light beam passes through the absorption path. The sensor arrangement further comprises a reference path that is sealed off (hermetically sealed) from the given environment and arranged such that the light beam passes through the reference path. A first light detector is arranged to detect the light beam exiting the absorption path and to generate a first output signal representative of an absolute CO₂ content in the given environment. A second light detector is arranged to detect the light beam exiting the reference section and to generate a second output signal representative of a CO₂ content at a constant level present in the reference section. Finally, the sensor arrangement has an evaluation unit with an amplifier, which is coupled on the input side to the first and second light detectors and is designed to provide an amplified difference signal from the first and second output signals at an output.

In the sensor arrangement, the reference section and the absorption section can be thermally coupled to each other, in particular arranged on a common carrier and/or having a common side.

In one aspect, the absorption path comprises a tube open to the environment and having a cavity arranged such that the light beam enters the cavity at a first end of the tube and exits the cavity at a second end of the tube. The reference path can be constructed in a similar manner. This creates an environment that is as uniform as possible, so that measurement errors due to different geometric structure or shape are reduced.

In one embodiment, the amplifier of the evaluation unit comprises a transimpedance amplifier that receives a current signal derived from the first output signal. In one aspect, a high-pass filter on the input side and a low-pass filter on the output side may be connected to the transimpedance amplifier, which are configured to receive the first output signal and the second output signal, respectively.

In one embodiment, the input side of the transimpedance amplifier may also be a high pass, while the gain circuitry of the transimpedance amplifier forms a low pass, and the overall system thus forms a band pass.

In another aspect, the at least one controlled light source comprises a first light emitter and a second light emitter, in particular of the same design, for generating a first pulsed light beam and a second pulsed light beam, the first and second light emitters being in particular thermally coupled to each other.

The sensing circuit may include a PWM circuit for generating a pulsed voltage/or current signal connected to the controlled light source.

Another aspect relates to a method for detecting a CO₂ content in a given environment. Here, a first and a second pulsed light beam are generated and the first light beam is detected after passing through an absorption path that communicates with the given environment and that comprises a length between 5 mm and 20 mm. Similarly, the second light beam is detected after passing through a reference path that is (hermetically) sealed from the given environment and comprises a predetermined CO₂ content and a length between 5 mm and 20 mm. Subsequently, an output signal is generated which is representative for the absolute CO₂ content in the given environment from a difference of the detected first and second light beam.

In a further embodiment, a light is detected after passing through the respective path, and a signal is generated from the detected light. This is filtered for further processing. The entire filtering is always in the sense of a bandpass.

According to a further embodiment, the absorption section has a length of between 8 mm and 15 mm. This helps to make the sensor arrangement particularly compact.

According to a further embodiment, the absorption path that communicates with the given environment is a cavity of a tube that is open towards the environment and that is arranged such that the light beam enters the cavity at a first end of the tube and exits the cavity at a second end of the tube. This helps to provide the absorption path in a particularly simple manner, which helps to make the sensor arrangement easy to manufacture.

According to a further embodiment, the tube has a diameter between 3 mm and 6 mm, for example between 4 mm and 5 mm, and can also comprise a length of 8 mm and 15 mm. This helps to ensure that a sufficiently large and/or representative volume is available along the absorption path and that the sensor arrangement can nevertheless be designed to be very compact.

According to a further embodiment, the light of the light beam has a wavelength in a range between 4 μm and 5 μm, in particular between 4.2 μm and 4.3 μm. This contributes to the fact that the absorption is essentially by the CO₂, since the absorption spectrum has an isolated maximum in this range for CO₂, as explained in the preceding. This helps to ensure that the determination of the CO₂ content is particularly precise.

In accordance with a further embodiment, the sensor arrangement has an evaluation unit which is electrically coupled to the amplifier and is designed in such a way that it determines the absolute CO₂ content by comparing the measured value and a reference value which is representative of a predefined CO₂ content. This helps to ensure that the determination of the CO₂ content is particularly precise.

According to a further embodiment, the sensor arrangement has a reference absorption path which is delimited airtightly from the surroundings, which has a predetermined absolute CO₂ content and which is arranged in such a way that a reference light beam, which is generated by means of a reference light source of the sensor arrangement or by splitting the light beam, passes through the reference absorption path. The reference light beam emerging from the reference absorption path is detected by means of the light detector or by means of a reference light detector of the sensor arrangement, which may be electrically coupled to the evaluation unit via the amplifier. The evaluation unit is designed in such a way that it determines the reference value as a function of the output signal of the light detector, which is generated on the basis of the reference light beam, or, if appropriate, as a function of the output signal of the reference light detector. This helps to ensure that the determination of the CO₂ content is particularly precise, since other influences on absorption, such as temperature, have an equal effect on the measured value and the reference value and cancel each other out when the two values are compared.

According to a further embodiment, the sensor arrangement has a memory unit, which is coupled to the evaluation unit or is encompassed by it and in which the reference value is stored. This helps to determine the reference value in a particularly simple manner, in particular without a reference light source, without a reference absorption path and without a reference light detector. This contributes to the sensor arrangement being particularly simple and/or inexpensive to manufacture.

According to a further embodiment, the evaluation unit comprises a microchip which is designed in such a way that it: depending on the output signal of the light detector at the output of the absorption cell, determines the absolute CO₂ content in the specified environment;
depending on the output signal of the light detector at the output of the absorption cell, by means of the comparison of the output signal of the light detector, which is generated on the basis of the light beam, and by means of the output signal of the light detector, which is generated on the basis of the reference light beam or, as the case may be, of the reference light detector, determines the absolute CO₂ content in the environment; or determines the absolute CO₂ content in the environment by means of the comparison of the measured value with the stored reference value.

The use of the microchip can contribute to the fact that the evaluation unit and thus the sensor arrangement can be manufactured in a particularly compact and/or simple design. The comparison of the measured value with the stored reference value can be carried out, for example, with the aid of a lookup table. The stored reference value can optionally depend on the application and/or external conditions, which is why a variety of possible reference values can be stored in the lookup table.

A problem is solved by a method for determining an absolute CO₂ content in a given environment, in which a light beam is generated by means of a light source; the light beam is detected by means of a light detector after passing through an absorption path which communicates with the given environment and which has a length of between 5 mm and 20 mm; and depending on an output signal of the light detector representative of a measurement value representative of the absolute CO₂ content in the given environment, determining the absolute CO₂ content in the given environment.

The further embodiments and/or advantages of the sensor arrangement presented in the foregoing can be transferred to the method without further ado. Therefore, in the sense of a concise disclosure, only the preceding explanations are referred to here and a repeated reproduction of the further embodiments and/or advantages is dispensed with.

According to a further embodiment, the absolute CO₂ content is determined by comparing the measured value with a reference value that is representative of a predetermined CO₂ content.

According to a further embodiment, the reference value is in a range between 50 mV and 150 mV, for example 100 mV.

According to a further embodiment, the reference value is predetermined or is determined by means of a reference absorption path and a reference light beam.

According to a further embodiment, the reference value is specified such that a difference between the reference value and the measured value is positive.

### BRIEF DESCRIPTION OF THE DRAWINGS

Examples of embodiments are shown in the figures and are explained in more detail below.

FIG. 1 shows an example of an absorption spectrum;

FIG. 2 shows a schematic representation of an embodiment of a sensor arrangement;

FIG. 3 shows an example of a sensor arrangement;

FIG. 4 shows a diagram illustrating exemplary photocurrents of light detectors as a function of a length of an absorption path;

FIG. 5A shows a graph illustrating a difference in the photocurrents shown in FIG. 3;

FIG. 5B shows a diagram illustrating a difference in the photocurrents shown in FIG. 3 due to a CO2 variation of 100 ppm in the absorption cell;

FIG. 6 shows a diagram illustrating an exemplary drive current for operating a light source;

FIG. 7 shows a diagram illustrating an exemplary frequency spectrum;

FIG. 8 shows a diagram illustrating a typical frequency distribution spectrum of noise sources;

FIG. 9 shows a diagram illustrating an example gain characteristic of a measuring amplifier;

FIG. 10 shows a diagram illustrating an example pulse response;

FIG. 11 shows a diagram illustrating an exemplary noise characteristic of a measuring amplifier;

FIG. 12 shows an example of an evaluation circuit;

FIG. 13 shows a diagram illustrating an example pulse responses with different gains;

FIG. 14 shows an example of a circuit for detecting and measuring a pulse height of a signal;

FIG. 15 shows a diagram illustrating an example differentiated pulse responses and integrated averaged pulse responses;

FIG. 16 shows an example of a controller for adjusting a pulse height;

FIG. 17 shows a diagram illustrating an example temperature dependence of a light source;

FIG. 18 shows an example of a circuit for correcting a temperature dependence of an emission energy of a light source;

FIG. 19 shows an example of an evaluation circuit with an additional measuring input for a further reference absorption path;

FIG. 20 shows an example of a circuit for increasing the sensitivity of a sensor array;

FIG. 21 shows an embodiment of a circuit for increasing a sensitivity of a sensor arrangement;

FIG. 22 is an example of a circuit for controlling a drive current;

FIG. 23 shows a flowchart of an embodiment of a method for detecting CO₂ content in a given environment.

### DETAILED DESCRIPTION

In the following detailed description, reference is made to the accompanying drawings which form part of this description and in which specific embodiments may be practiced are shown for illustrative purposes. Since components of embodiments may be positioned in a number of different orientations, the directional terminology is for illustrative purposes and is not limiting in any way. It is understood that other embodiments may be used and structural or logical changes may be made without departing from the scope of protection. It is understood that the features of the various embodiments described herein may be combined with each other, unless specifically indicated otherwise. Therefore, the following detailed description is not to be construed in a limiting sense, and the scope of protection is defined by the appended claims. In the figures, identical or similar elements are indicated by identical reference signs where appropriate.

An optoelectronic assembly may have one, two or more optoelectronic components. Optionally, an optoelectronic assembly may also have one, two, or more electronic components. For example, an electronic component may have an active component and/or a passive component. An active electronic component may comprise, for example, a computing, control and/or regulating unit and/or a transistor. A passive electronic component may have, for example, a capacitor, a resistor, a diode, or an inductor.

An optoelectronic device can be an electromagnetic radiation emitting device or an electro-magnetic radiation absorbing device. An electromagnetic radiation absorbing device may be, for example, a solar cell. In various embodiments, an electro-magnetic radiation emitting device may be a semiconductor electromagnetic radiation emitting device and/or may be formed as an electromagnetic radiation emitting diode, an organic electromagnetic radiation emitting diode, an electromagnetic radiation emitting transistor, or an organic electromagnetic radiation emitting transistor. The radiation may be, for example, light in the visible range, UV light, and/or infrared light. In this context, the electromagnetic radiation emitting device may be, for example, a light emitting diode (LED), an organic light emitting diode (OLED), a light emitting transistor, or an organic light emitting transistor. In various embodiments, the light emitting device may be part of an integrated circuit. Further, a plurality of light emitting devices may be provided, for example housed in a common package.

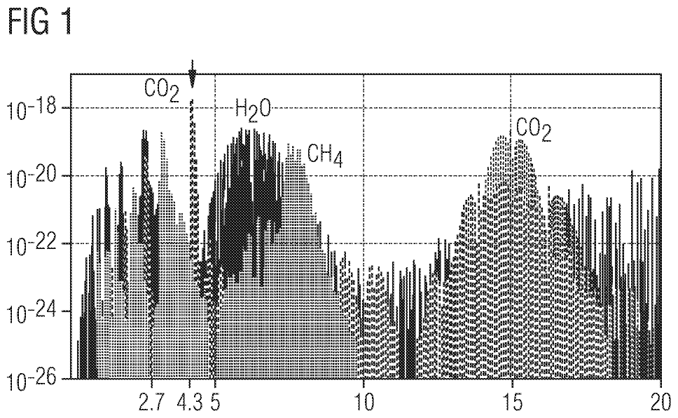

FIG. 1 shows an example of an absorption spectrum. From the absorption spectrum, it can be seen that CO₂ exhibits strong light absorption in the range between 4.2 μm and 4.3 μm. More-over, neither strong absorption by other molecules nor strong background noise occurs in this range. Therefore, this wavelength range is very suitable for determining the CO₂ content in a given environment. The given environment can be, for example, a building, one or more rooms in the building, or an area outside a building.

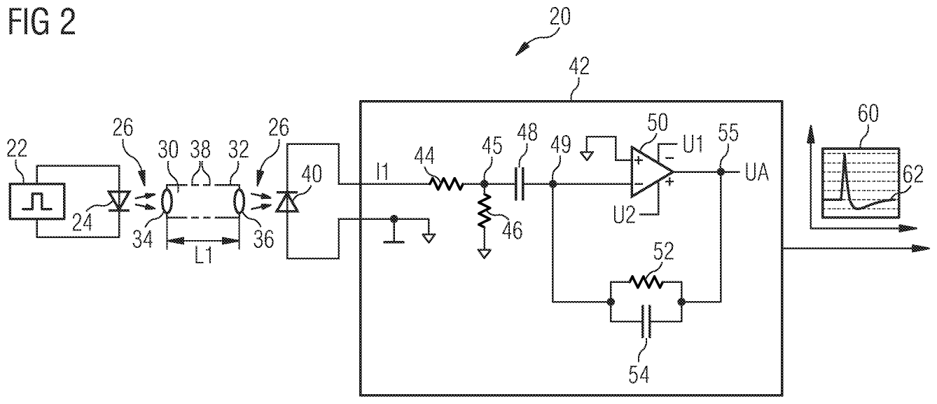

FIG. 2 shows a schematic diagram of an embodiment of a sensor arrangement 20. The sensor arrangement 20 may also be referred to as the first sensor arrangement 20. The first sensor arrangement 20 comprises a power source 22, a light source 24, an absorption path 30, a light detector 40 and an amplifier 42. The sensor arrangement 20 may be arranged in whole or in part on a printed circuit board. When the sensor arrangement 20 is used as intended, the sensor arrangement 20 is electrically coupled to an evaluation unit (not shown in the figures). For example, the sensor arrangement 20 and/or the evaluation unit may be portable. For example, the sensor arrangement 20 and/or the evaluation unit may be integrated in a portable electronic device. The portable electronic device may be, for example, a laptop, tablet, or cell phone.

The power source 22 is electrically connected to the light source 24 and is used to provide power to the light source 24. The energy source 22 may be, for example, a current source or a voltage source. The energy source 22 is suitable, for example, for generating energy pulses, in particular current pulses, for example for generating current pulses of 1 A each for 200 μs with a pulse frequency of 60 Hz.

The light source 24 is used to generate a light beam 26 such that it passes through the absorption path 30. The light source 24 may generate the light beam 26 such that its wavelength is in the mid-infrared range, for example between 4.2 μm and 4.3 μm, for example at about 4.23 μm. The light source 24 comprises or is formed by an LED, for example.

The absorption path 30 communicates with an environment of the sensor arrangement 20, meaning that a free exchange of air and/or gas can occur between the absorption path 30 and the environment of the sensor arrangement 20. For example, the absorption path 30 is located in a tube 32. The tube 32 has a first end 34 facing the light source 24 and a second end 36 facing the light detector 40. The tube 32 and the absorption path 30 are formed and arranged such that the light beam 26 enters the tube 32 through the first end 34 and exits the tube 32 through the second end 36. The ends 34, 36 may, for example, be open or closed by means of a respective transparent element for the light beam 26. For example, the transparent element may be an optical element for affecting the light beam 26. For example, the optical element may be a lens, such as a focusing lens or a collimating lens. For example, the tube 32 may include openings 38 toward the environment through which air and/or gas exchange may occur between the absorption section 30 and the environment of the sensor arrangement 20.

For example, the absorption section 30 has a length L in the range between 5 mm and 20 mm, for example between 10 mm and 15 mm. The length L of the absorption section 30 represents an optimum compromise between a sufficiently large length L of the absorption section 30 to allow sufficient absorption and a sufficiently large length L of the absorption section 30 to allow sufficient absorption and a sufficiently short length L of the absorption path 30 to generate a sufficiently strong signal at the light detector 40, as explained in more detail with reference to the following figures.

The light detector 40 is, for example, a photodiode that is sensitive, in particular, in the mid-infrared range, in particular, wavelength range between 4.2 μm and 4.3 μm.

Optionally, an optical filter not shown in the figures can be arranged in the beam path of the light beam 26 between the tube 32 and the light detector 40, which essentially transmits light in the mid-infrared range, for example in the wavelength range between 4.2 μm and 4.3 μm, and blocks light of other wavelengths. When a light pulse of the light beam 26 is detected, the light detector 40 generates a first current I1, in particular a photocurrent of the corresponding photodiode. The first current I1 is supplied to an input of the amplifier 42 as an input signal.

The amplifier 42 is, for example, a transimpedance amplifier that converts the first current I1 into an output voltage UA. The transimpedance amplifier has, for example, a transimpedance of 1 μV/pA. The output voltage UA may be, for example, approximately 100 mV. The amplifier 42 includes an evaluation circuit.

In this embodiment, the evaluation circuit comprises a first resistor 44 connected to the input of the amplifier 42 on one side and to a first node 45 on the other side. A second resistor 46 of the evaluation circuit is connected to the first node 45 and to ground. A first capacitor 48 of the evaluation circuit is connected on one side to the first node 45 and on the other side to a second node 49.

The first capacitor 48 may comprise a capacitance of 330 nF, for example. A first comparator 50 of the evaluation circuit is connected at its negative input (V−) to the second node 49 and at its positive input (V+) to ground.

In addition, a first voltage U1 and a second voltage U2 are supplied to the comparator 50 as reference voltages. An output of the comparator 50 is connected to a third node 55. A third resistor 52 of the evaluation circuit is connected on the one hand to the second node 49 and on the other hand to the third node 55. A second capacitor 54 of the evaluation circuit is connected on one side to the second node 49 and on the other side to the third node 55. The third node 55 is coupled to an output of the amplifier 42.

For example, the first resistor 44 may comprise an ohmic resistance of 1 kΩ. The first capacitor 82 may comprise a capacitance of 330 nF, for example. The third resistor 52 may comprise, for example, an ohmic resistance of 1 MΩ. The second capacitor 54 may comprise a capacitance of 22 pF, for example.

A first graph 60 shows a first curve 62 showing a waveform of an output pulse of an output signal of the amplifier 42.

The evaluation unit is electrically coupled to the output of the amplifier 42 and is used to determine the absolute CO₂ content along the absorption path 30, in particular in the tube 32, and thus in the environment, based on the output signal of the amplifier 42. The evaluation unit may be, for example, a computing unit comprising an electronic circuit and/or a microchip.

Based on the following figures, it is explained in detail that the length L in the range between 5 mm and 20 mm, for example between 10 mm and 15 mm, of the absorption section 30 is particularly suitable for determining the CO₂ content.

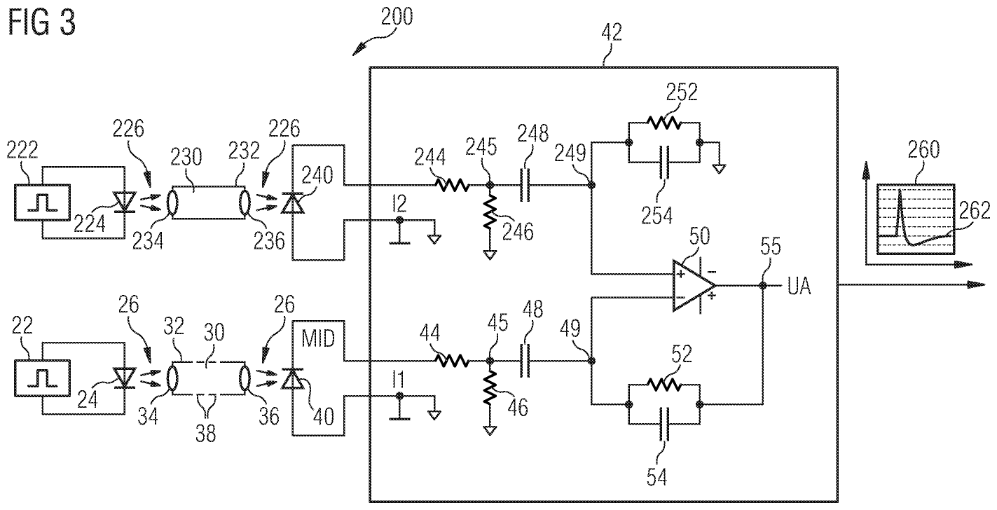

FIG. 3 shows a schematic representation of an embodiment of a sensor arrangement 200. The sensor arrangement 200 may be arranged entirely or partially on a printed circuit board. The sensor arrangement 200 may also be referred to as the second sensor arrangement 200. The second sensor arrangement 200 comprises a measurement section and a reference section. The measuring section is substantially the same as the first sensor arrangement 20 explained above with reference to FIG. 2, so no further description of the elements of the measuring section is provided here, and reference is made only to the foregoing discussion of the first sensor arrangement 20. The reference section includes a reference energy source 222, a reference light source 224, a reference absorption path 230, a reference light detector 240, and the amplifier 42.

When the sensor arrangement 200 is used as intended, the sensor arrangement 200 is electrically coupled to an evaluation unit (not shown in the figures). The sensor arrangement 200 and/or the evaluation unit may, for example, be designed to be portable. For example, the sensor arrangement 200 and/or the evaluation unit may be integrated in a portable electronic device. The portable electronic device may be, for example, a laptop, tablet, or cell phone. Optionally, the evaluation unit may have, for example, an ADC as an input and a digital processor unit as a core component.

The reference energy source 222 is electrically connected to the reference light source 224 and is used to supply energy to the reference light source 224. The reference energy source 222 may be, for example, a current source or a voltage source.

The reference energy source 222 is suitable, for example, for generating energy pulses, in particular current pulses, for example for generating current pulses of 1 A each for 200 μs with a pulse frequency of 60 Hz.

The reference light source 24 is used to generate a reference light beam 26 such that it passes through the reference absorption path 30. The reference light source 24 may generate the reference light beam 26 such that its wavelength is in the mid-infrared range, for example between 4.2 μm and 4.3 μm, for example at about 4.23 μm. The reference light source 24 comprises or is formed by an LED, for example.

The reference absorption path 230 does not communicate with an environment of the sensor arrangement 200, which means that no air and/or gas exchange can occur between the reference absorption path 230 and the environment of the sensor arrangement 200. For example, the reference absorption path 230 is located in a reference tube 232. Along the reference absorption path 230, for example in the reference tube 232, a constant, optionally known and/or predetermined CO₂ content is present. For example, the reference absorption path 230 may be free of CO₂.

The reference tube 232 includes a first end 234 facing the reference light source 224 and a second end 236 facing the reference light detector 240. The reference tube 232 and the reference absorption path 230 are formed and arranged such that the reference light beam 226 enters the reference tube 232 through the first end 234 and exits the reference tube 232 through the second end 236. The ends 234, 236 of the reference tube 232 may, for example, each be closed, in particular sealed, by means of an element transparent to the reference light beam 226 so that no air and/or gas exchange occurs between the interior of the reference tube 232 and the environment. For example, the transparent element may be an optical element for affecting the reference light beam 226. For example, the optical element may be a lens, such as a focusing lens or a collimating lens.

The reference absorption section 230 may comprise the same length L as the absorption section 30. For example, the reference absorption section 230 comprises a length L in the range between 5 mm and 20 mm, for example between 10 mm and 15 mm.

Alternatively, the length of the reference absorption path 230 may be different from the length of the absorption path 30. In such a case, the difference based on the difference of the lengths can be compensated at the inputs of the measuring amplifiers with resistors, for example with 1Ω to 100Ω.

The reference light detector 240 is, for example, a photodiode that is sensitive, in particular, in the mid-infrared range, in particular, a wavelength range between 4.2 μm and 4.3 μm. Optionally, an optical filter not shown in the figures may be arranged in the beam path of the reference light beam 226 between the reference tube 232 and the reference light detector 240 to substantially transmit light in the mid-infrared range, for example in the wavelength range between 4.2 μm and 4.3 μm, and block light of other wavelengths. When a light pulse of the reference light beam 226 is detected, the reference light detector 240 generates a second current I2, particularly a photocurrent of the corresponding photodiode. The second current I2 is supplied as an input signal to an input of the amplifier 42.

The amplifier 42 is, for example, a transimpedance amplifier that converts the first current I1 and the second current I2 into an output voltage UA. The transimpedance amplifier has, for example, a transimpedance of 1 μV/pA. The output voltage UA may be, for example, approximately 100 mV. The amplifier 42 includes an evaluation circuit.

In this embodiment, in addition to the components explained with reference to FIG. 2, the evaluation circuit includes a twenty-eighth resistor 244 connected to a second input of the amplifier 42 and to a twentieth node 245. A twenty-ninth resistor 246 is connected to the twentieth node 245 and to ground. A ninth capacitor 248 is connected to the twentieth node 245 on one side and to a twenty-first node 249 on the other side. The first comparator 50 is connected at its negative input to the second node 49 and at its positive input to the twenty-first node 249. The output of the comparator 50 is connected to the third node 55. A thirtieth resistor 252 is connected at one end to the twenty-first node 249 and at the other end to ground. A tenth capacitor 254 is connected to the twenty-first node 249 on one side and to ground on the other side. The third node 55 is coupled to the output of the amplifier 42.

For example, the ninth capacitor 248 may comprise a capacitance of 330 nF. The thirtieth resistor 252 may comprise, for example, an ohmic resistance of 10 MΩ. The tenth capacitor 254 may comprise, for example, a capacitance of 22 pF. The twenty-eighth resistor 244 may comprise, for example, an ohmic resistance of 1 KΩ. The twenty-ninth resistor 246 may comprise an ohmic resistance of 1 kΩ, for example.

A second graph 260 shows a fourth graph 262 showing a waveform of an output pulse of an output signal of the amplifier 42. The output signal is present at the TIA output if the reference tube 232 is also connected. Here the typical signal level is only 10 mV instead of 100 mV compared to FIG. 2.

The evaluation unit is electrically coupled to the output of the amplifier 42 and is used to determine the absolute CO₂ content along the absorption path 30, in particular in the tube 32, and thus in the environment, based on the output signal of the amplifier 42. The evaluation unit may be, for example, a computing unit comprising an electronic circuit and/or a microchip.

The reference section, which can also be referred to as the reference cell, is used to determine a reference value for the CO₂ content. The reference section is exposed to the same environmental conditions as the measuring section. For example, the reference section has the same temperature as the measurement section. Therefore, all influences that affect a measurement signal generated by means of the measurement section also affect a reference signal determined by means of the reference section. In the first comparator 50, the measurement signal and the reference signal are compared with each other, for example by subtracting them from each other. The resulting output voltage UA is then adjusted for these external influences.

As an alternative to determining the reference signal using the reference section, one, two or more reference values can also be specified, stored on a memory unit not shown, and compared with corresponding measured values.

The first current I1 and the second current I2 can be determined as follows depending on the length L:

$$I 1 ( L ) = IPho [ \frac{kL}{{( d - do )}^{n}} ] \cdot {e}^{- μ CO 2 \cdot L} \\ I 2 ( L ) = IPho [ \frac{kL}{{( d - do )}^{n}} ]$$

where, if μCO₂*L<<1, I1 can be determined by:

$$I 1 ( L ) = IPho [ \frac{kL}{{( d - do )}^{n}} ] \cdot ( 1 - μ CO 2 \cdot L )$$

where, for example, do=−1 mm is the position of the light detector 40 with respect to the geometric light path, for example, d=10 mm is the position of the light source 24 with respect to the effective absorption path, for example, n=1.2 is the optical beam dilution form factor, with the characteristics of the light detectors 40, 240:
the current received at the light detectors 40, 240

IPho=Rph*PLed0,
of the light pulse power received at the light detectors 40, 240, which can be calculated using the following model consideration:

PLedo=Dilution(L)*uFilt*uOpt*PLed_pulse

wherein

$$Dilution ( L ) = [ \frac{kL}{{( d - do )}^{n}} ]$$

with for example

Dilution(10 mm)=5.1*10⁻²

and thus

$$PLedo = [ \frac{kL}{{( d - do )}^{n}} ] \cdot uFilt \cdot uOpt \cdot PLed\_pulse \\ with \\ uFilt = \frac{Δ B}{B\_NIR} \\ B\_NIR = λ max - λ min$$

where for example
λmin=0.8 μm the upper MDIR-range band end,
λmax=4.8 μm the lower MDIR-range band end
B_NIR=4 μm the total MDIR-range spectral bandwidth,
ΔB=0.1 μm the filtered out MDIR-range bandwidth,
uFilt=2.5%,
   and uOpt=5% is the optical light generation efficiency of an IR LED (i.e. only 5% of the electrical energy conducted to is converted to light in an IR LED).

Explanatory it is pointed out that in the above model it is assumed that the light source 24, 224 does not sit mathematically at 0 mm but at −1 mm, so that with theoretically smallest absorption path length L of 0 mm the dilution term kd/(d−do)ⁿ does not become infinite. do=−1 mm is thus an exemplary model parameter with which one can simulate the optical dilution along the absorption path 30 or the reference absorption path from 0 mm to x mm. Alternatively, do=−0.0001 mm would be possible, for example, in which case the remainder could be adjusted with a correspondingly different kL.

This results in a light pulse power typically received at the light detectors 40, 240 to:

PLedo=127 μW

which corresponds to a typical IR light pulse in the light detector 40, 240 downstream of the absorption path 30 and the reference absorption path 230, respectively.

In the following PLed0 is set to 100 μW for simplicity.

By looking at the photodiode sensitivity in the MIR range or the pin sensitivity of the light detectors 40, 240

$$Rpin = \frac{e}{hv}$$

with, for example, λ=4.2 μm, v=c/λ, so that, for example, Rpin=3.385 A/W is the theoretical maximum value, assuming that one electron is generated per photon of energy Eph=hv, and Rph=1A/W is the typical PIN sensitivity of IR photodiodes, the received current signal of IPho=100 μA can be modelled.

For example, a conversion of the CO₂ concentration CO₂ ppm to the Lambert-Beer absorptivity coefficient μCO₂ is done with the molarities:
the molar mass of CO₂ MCO₂=44 g/mol,
the molar mass of air MLuft=28.9647 g/mol, and
the standard molar volume Vmol=22.710947 l;
   with the formula for converting ppm to CO₂-mass densities:

ρCO₂=(MCO₂/Vmol)*(ppmCO₂*ppm/(1−ppmCO₂*ppm)),

and the CO₂-content of ppmCO₂=401, near the earth in 2015 results in a CO₂-mass density of

ρCO₂=775 mg/m³ at 400 ppm CO₂ content in air,

The following values are verification values only to consolidate the applied formula:

ρCO₂=969 mg/m³ at 500 ppm CO₂ in air,

and

ρCO₂=1940 mg/m³ at 1000 ppm CO₂ in air.

The results for values of poor air quality in

$${ppmCO}_{2} = 10000 results in ρ {CO}_{2} = 1.967 * {10}^{4} mg / {m}^{3} = ρ CO 2 = 19574 \cdot \frac{mg}{{m}^{3}}$$

With the formula for the molar concentration (molar density)

cmolCO₂=ρCO₂/MCO₂,

the following values are obtained for the molar concentration:

cmolCO2=0.018441 mol/m³ Mold density at CO2 content=400 ppm

cmolCO2=0.0441 mol/m³ Mold density at CO2 content=1000 ppm

cmolCO2=0.445 mol/m³, Mold density at CO2 content=10000 ppm

With the extinction coefficients of CO₂ at the wavelength 4.3 μm:

εCO₂=29.9 m²/mol for 4.3 μm, (from HITRAN, lookup value).

Using the extinction coefficient and the molar concentration, the Lambert-Beer absorption coefficient can be calculated with the following formula to:

μCO₂=εCO₂_mol cmol_CO₂

Thus, starting from the table value for the extinction coefficient εCO₂=29.9 m²/mol at 4.3 μm for different CO2 ppm values the following Lambert-Beer absorption coefficient can be calculated.

μCO₂=0.527 1/m for CO₂=400 ppm

μCO₂=1.318 1/m for CO₂=1,000 ppm,

and

μCO₂=13.298 1/m for CO₂=10,000 ppm.

Using the characteristics of the absorption paths 30, 230 as d0=−1 mm for the position of the light detectors 40, 240 relative to the origin of the geometric light path, d=10 mm for the position of the light source 24, 224 relative to the origin of the absorption path, n=1,2 for the optical beam dilution factor for the tube 32, 232, and kd=1 mmⁿ for the shape factor for the tube 32, 232, the signal currents at the photodiodes can be represented as a function of the length of the absorption cells as well as a function of the CO₂ concentration.

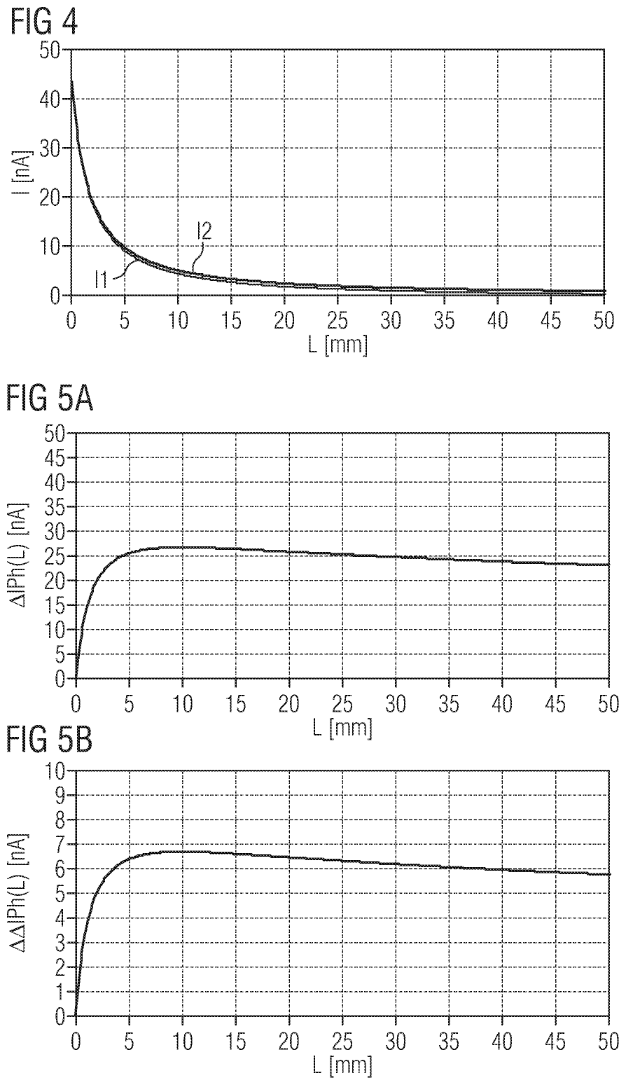

FIG. 4 shows a diagram illustrating an example of the first current I1 generated by means of the light detector 40 and the second current I2 generated by means of the reference light detector 240 as a function of the length L of corresponding absorption paths, for example the absorption path 30 and the reference absorption path 230. On the X-axis, the length L of the absorption path and the reference absorption path 230 is plotted in millimeters, and on the Y-axis, the first current I1 of the light detector 40 and the second current I2 of the reference light detector 240 are plotted.

For both curves, the measured light intensities decrease with increasing length L in accordance with an emission characteristic of the corresponding light source 24, 224.

This is essentially because the intensities of the light beams 26, 226 decrease with increasing distance between the light sources 24, 224 and the corresponding light detectors 40, 240.

In this case, the curve for the second current I2 lies above the curve for the first current I1, because in this example the reference absorption section 230 is free of CO₂, which is why less light is absorbed along the reference absorption section 230 than at the absorption section 30 and more light arrives at the reference light detector 240 than at the light detector 40, resulting in a larger current in the reference section compared to the measurement section.

However, there is another effect which is not clearly visible in FIG. 4. The longer the absorption distance, the higher the absorption probability.

A relatively short absorption distance thus results in a relatively high measurable light intensity, but has a lower absorption probability.

A long absorption distance, on the other hand, results in a relatively low measurable light intensity, but comprises a relatively high absorption probability. This effect can be illustrated by subtracting the first current I1 from the second current I2.

FIG. 5A shows a diagram with a difference curve representative of a difference between the currents I1 and 12 shown in FIG. 3. The difference curve comprises an absolute maximum in the range between 5 mm and 20 mm, in particular between 8 mm and 15 mm. The absolute maximum arises due to the effects of the decrease in the intensity of the light beams 26, 226 with increasing length L and the increase in the probability of absorption with increasing length L, as explained above.

Thus, the optimum length L of the absorption section 30 is in the range between 5 mm and 20 mm, in particular between 8 mm and 15 mm.

FIG. 5B shows a diagram showing a difference in the photocurrents shown in FIG. 3 due to a CO₂ variation of 100 ppm in the absorption cell. This figure shows how the current difference signal behaves when the CO₂ content is changed by 100 ppm compared to the diagram shown in FIG. 5a. The maximum of the difference signal is still about 10 mm.

For the quantities assumed in the foregoing, in particular the energies, the currents and the length L, the corresponding output signal can depend sensitively on various factors. These factors will be explained in the following, showing among other things how their influences on the measurement result can be kept particularly low.

In a non-limiting embodiment, the light sources 24, 224 are pulsed LED light sources. These act practically like a chopper. The light signal is thus encoded in a pulse form and not in a static measurement signal. This has the advantage that the signal components in the Fourier domain are not seen at f=0 Hz=DC, but in a different frequency range, for example at f=500 Hz. This can also be called the chopper principle. With this approach, the measurement signal or the measurement in the Fourier domain can be made at suitable points where little noise is present and/or expected. If one sets the measuring signal by Pulsing, also called Choppering, into the measuring range of 500 Hz, then one can receive the signal at this point with a narrow-band filter and measure with low noise. The narrower the chopper pulse (200 μm in the present example), the wider the measurement signal is scattered over the entire Fourier range.

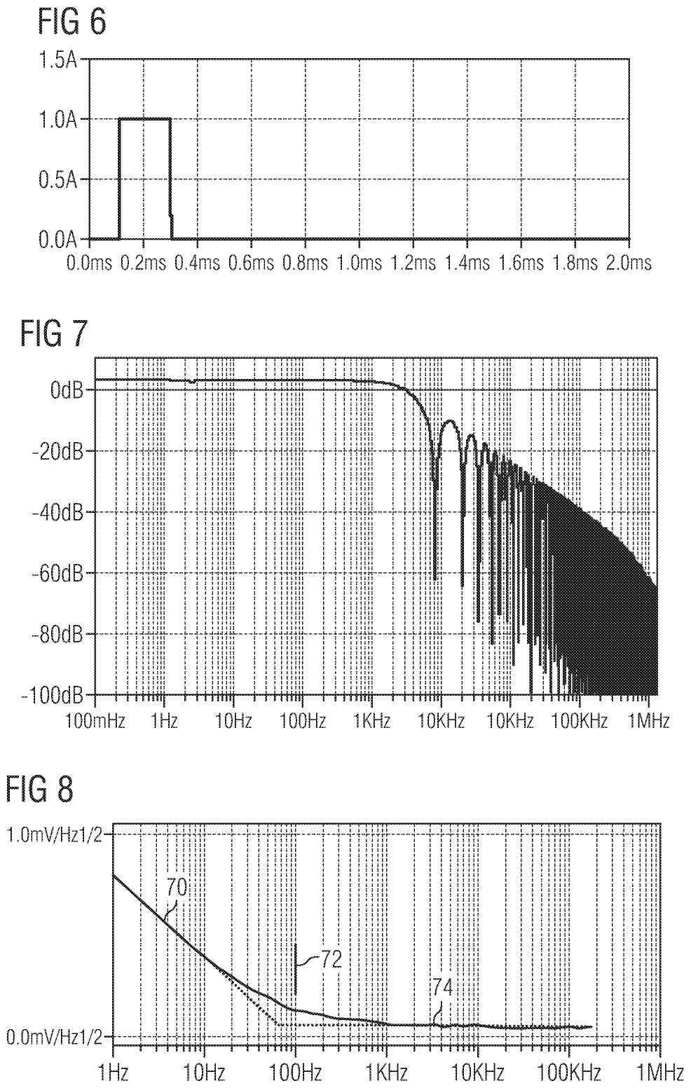

FIGS. 6 to 11 illustrate the short light pulses in conjunction with a narrowband receiver with suitable center frequency to avoid the structural noise sources and to increase the signal-to-noise ratio SNR.

FIG. 6 shows a diagram illustrating an exemplary drive current for driving a light source, such as light source 24 or reference light source 224. The diagram shows a single current pulse of 1 A for a duration of 200 μs, which causes the corresponding light source to generate a corresponding light pulse.

FIG. 7 shows a diagram illustrating an exemplary frequency spectrum. In particular, the diagram shows the frequency spectrum of the intensity of the light beam 26, 226 generated in response to the drive current explained with reference to FIG. 6.

In particular, in this embodiment example, the 200 μsec pulse signal is scattered to the frequency range below 5 kHz (with the slit function (sin x/x)²). This means that with the 200 μsec the measurement signal is scattered to a range of 1/200 μsec=5 kHz. Now, regardless of the pulse frequency itself, signal components can be recorded at a suitable location below 5 kHz, for example at 500 Hz, using a narrowband amplifier. The pulse repetition frequency of 60 Hz is then largely irrelevant. The frequency components of the 200 μsec light pulse drop off significantly above 5 kHz, which is also referred to as roll-off. The rest of the measured signal are side lines and/or harmonics, which are hardly visible in the diagram shown, since it has a dB scale.

FIG. 8 shows a diagram illustrating a typical frequency distribution spectrum of noise sources, especially structural noise sources. A first section 70 of the trace shown in the frequency section less than 100 Hz is representative of a l/f noise. A second section 72 at about 100 Hz is representative of a dominant energy line. A third section 74 above 1 kHz is representative of a broadband dark current noise.

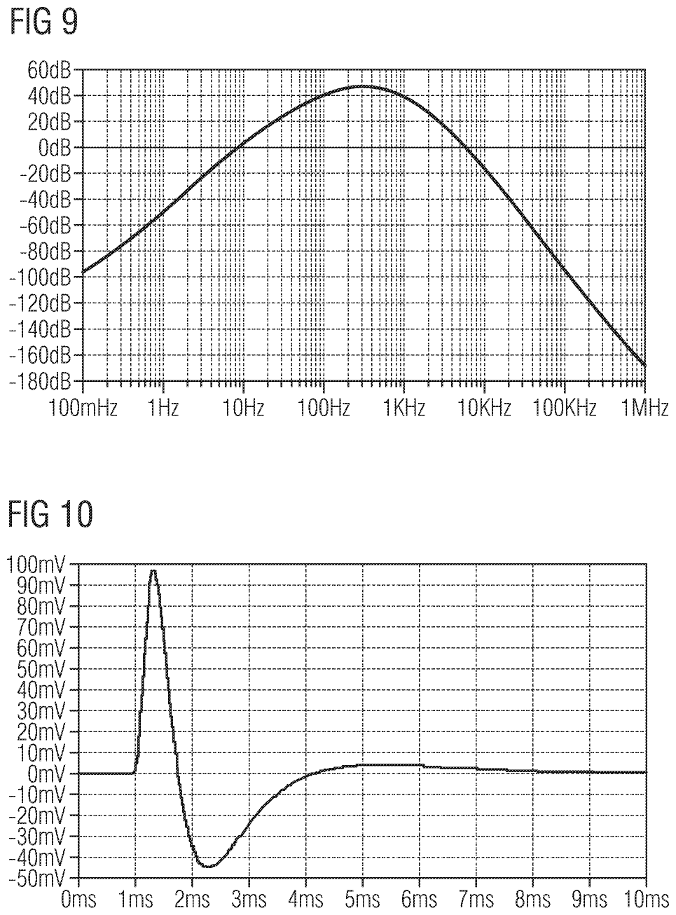

FIG. 9 shows a diagram illustrating an exemplary detection characteristic of a transimpedance amplifier, in particular amplifier 42. The voltage curve shown has its maximum at about 500 Hz. The maximum is clearly above the structural noise sources explained in the foregoing and in particular still below 5 kHz, where one can still see appreciable signal components of the pulsed light measurement signal.

FIG. 10 shows a diagram illustrating an exemplary pulse response, in particular the pulse response of the narrow bandwidth amplifier 42. The pulse response shows a differentiating and an integrating behavior. The remaining DC component of the pulse is completely suppressed.

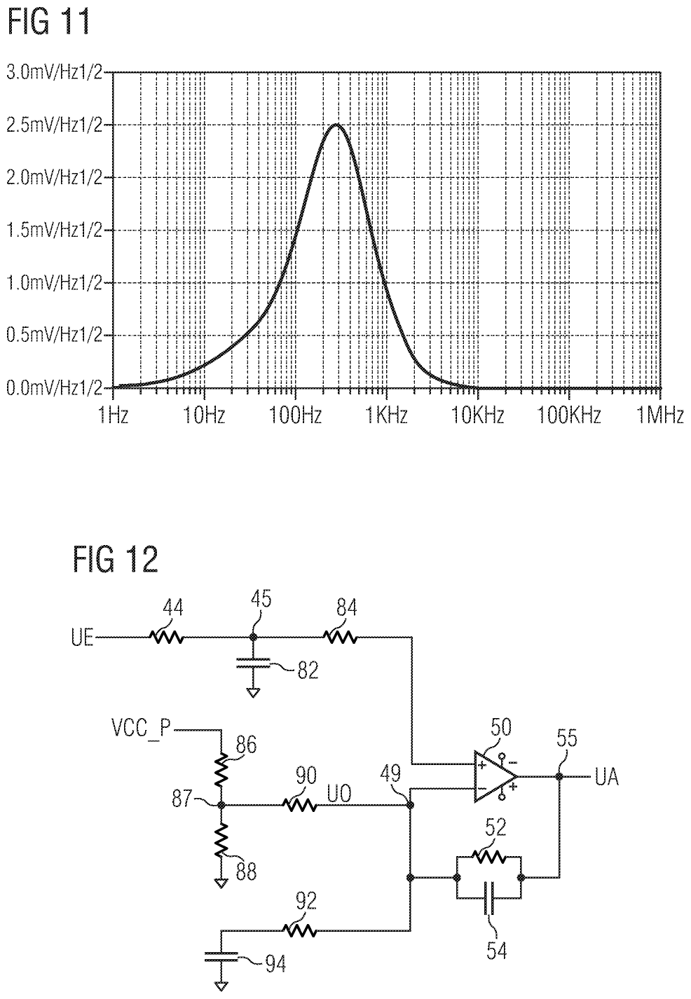

FIG. 11 shows a diagram illustrating an example expected noise background, in particular of the amplifier 42 with narrow bandwidth in the frequency domain. This will result in a noise background of 1 mV²/100R=10 nW, corresponding to a detectability of 10 pW (−30 dB) at the input of amplifier 42. From the noise values at the output of the (first) measuring amplifier 1 mV/(Hz), a noise value of 1 mV/(Hz)/10³=1 nA/(Hz) can be calculated via the amplification factor, for example 30 dB, at the input. This noise figure is then the smallest signal measurement change that can still be detected. In the case of the present CO₂ measuring cell, this corresponds to a CO₂ concentration change of 20 ppm, which means that the system sensitivity can be characterized as 20 ppmCO₂/(Hz).

FIG. 12 shows an embodiment of an evaluation circuit. For example, the evaluation circuit may be a part of the amplifier 42 or may constitute the amplifier 42. In contrast to the evaluation circuit of the amplifier 42 explained with reference to FIG. 2, the evaluation circuit in this embodiment has the possibility of offset adjustment. In the following, only the components of the evaluation circuit that differ from the evaluation circuit explained with reference to FIG. 2 will be described. With regard to the other components, reference is made to the above explanations with reference to FIG. 2.

An input voltage UE may be provided, for example, by the light detector 40 or the reference light detector 240. A third capacitor 82 is connected on the one hand to the first node 45 and on the other hand to ground. A fifth resistor 84 is electrically connected on the one hand to the first node 45 and on the other hand to the positive input (V+) of the first comparator 50. A sixth resistor 86 is electrically connected on the one hand to a positive input voltage VCC_P and on the other hand to a fifth node 87. A seventh resistor 88 is electrically connected on the one hand to the fifth node 87 and on the other hand to ground. An eighth resistor 90 is electrically connected on the one hand to the fifth node 87 and on the other hand to the second node 49. A ninth resistor 92 is electrically connected on the one hand to the second node 49 and on the other hand to a fourth capacitor 94.

The fourth capacitor 94 is electrically connected to the ninth resistor 92 on the one hand and to ground on the other. The third capacitor 82 may comprise a capacitance of 330 nF, for example. The fifth resistor 84 may comprise, for example, 1 kΩ. The fourth capacitor 94 may comprise a capacitance of, for example, 330 nF. The ninth resistor 92 may comprise, for example, 1 kΩ. The sixth resistor 86 may comprise, for example, 1 kΩ. The seventh resistor 88 may comprise, for example, 10 kΩ. The eighth resistor 90 may comprise, for example, 100 kΩ.

In this example, the first comparator 50 can be configured as a high power pulse amplifier. The circuit around the comparator 50 forms the desired narrowband amplifier as a whole, the maximum sensitivity of which is, for example, about 500 Hz, with which it is possible to amplify the main components of the 200 μsec pulses well.

The virtual ground at the negative input of the first comparator 50 is a good fit for injecting an offset voltage across the eighth resistor 90 and the second node 49. The offset voltage serves as a reference for shifting the current pulses at the input to a beginning of a linear range near zero volts (ground) for subsequent detailed pulse wave analysis.

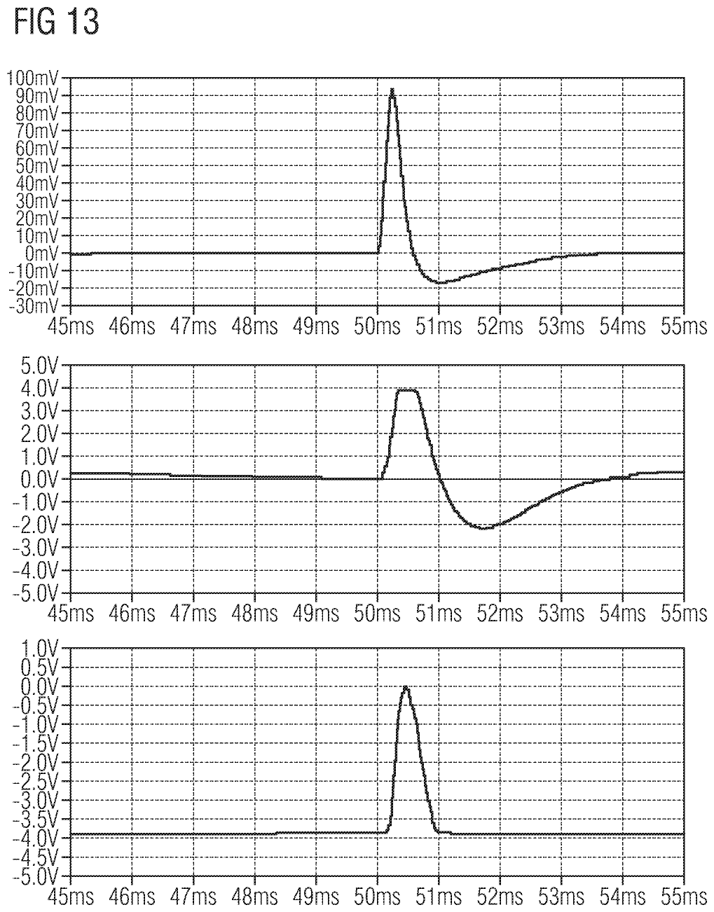

FIG. 13 shows a diagram illustrating exemplary pulse responses. In particular, the diagram shows three voltage curves below each other, each representative of a pulse. The upper voltage curve shows an unamplified input pulse with a maximum near 100 mV. The middle curve shows an amplified pulse at the output of amplifier 42. This amplified output pulse exceeds the end of scale of the output stage of amplifier 42. This causes the maximum of the curve to be truncated, resulting in the loss of information about the exact magnitude of the maximum of the pulse. This can be handled by adding the offset voltage. The lower curve shows the amplified pulse at the output of amplifier 42, with the pulse shifted by the offset voltage to the linear region near zero volts. In this range, the pulse can be precisely analyzed with respect to an exact change in pulse height.

The sensitivity of the sensor arrangement 20, 200 can be in-creased by means of scrambling and modulating the light beam 26, 226 in cycles of narrow pulses, which allows autonomous voltage-controlled detection and integration when the pulsed signal is present.

In an alternative concept, the sensitivity can increase while excluding temperature effects. In particular, the LED light signal can be encoded and/or modulated in a predetermined manner and then detected in a modulation-sensitive manner, which can also be referred to as the lockin amplifier principle.

Precise voltage-controlled pulse integration may be performed in the linear region of the amplifier 42 near zero volts (ground). Therefore, the pulses are shifted so that their maxima are near ground by biasing the amplifier with a predetermined offset voltage. The voltage controlled pulse integration can then be performed by using a circuit to detect and measure the pulse height of the signal.

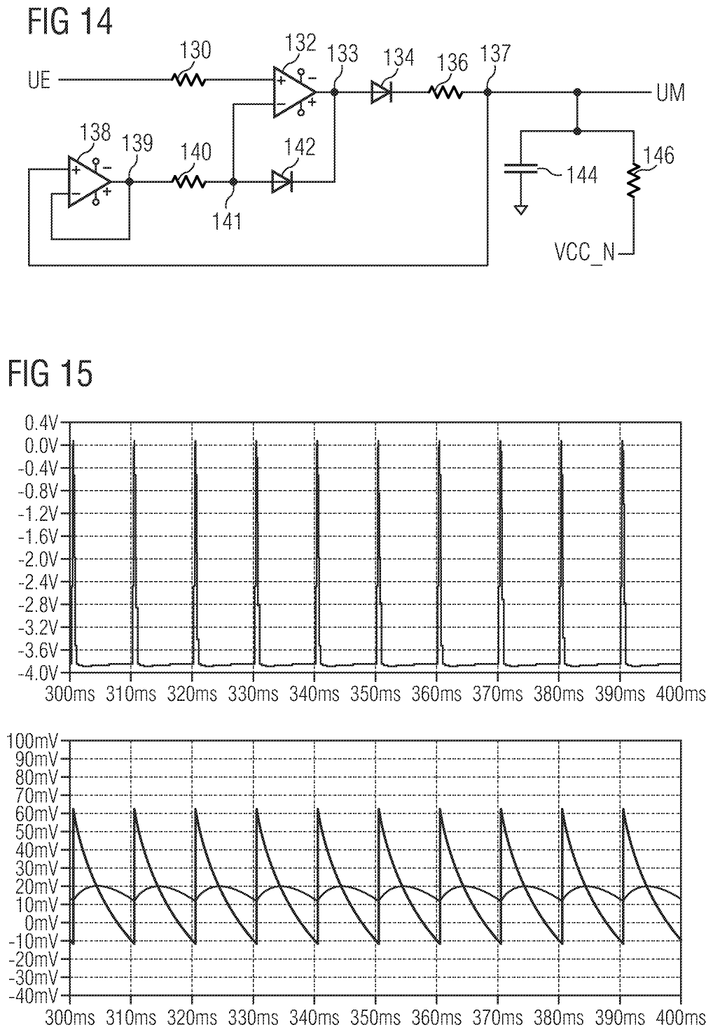

FIG. 14 shows an embodiment of a circuit for detecting and measuring a pulse height of a signal. The circuit monitors the average maxima of the incoming signals. The circuit comprises an input to which an input voltage UE is applied. The input voltage UE may correspond, for example, to the output voltage UA explained with reference to FIG. 12. In particular, the circuit shown in FIG. 14 may be connected downstream of the circuit shown in FIG. 12. An eleventh resistor 130 is electrically connected on the one hand to the input of the circuit and on the other hand to a positive input (V+) of a third comparator 132. An output of the third comparator 132 is electrically connected to an eighth node 133. A first diode 134 is electrically connected on one side to the eighth node 133 and on the other side to a twelfth resistor 136. The twelfth resistor 136 is electrically connected on one side to the first diode 134 and on the other side to a ninth node 137. A fourth comparator 138 is electrically connected at its positive input (V+) to the ninth node 137 and is electrically connected at its negative input (V−) and at its output to a tenth node 139. A thirteenth resistor 140 is electrically connected at one end to the tenth node 139 and at the other end to an eleventh node 141. A negative input (V−) of the third comparator 132 is electrically connected to the eleventh node 141. A second diode 142 is electrically connected on one side to the eleventh node 141 and on the other side to the eighth node 133. A sixth capacitor 144 is electrically connected on one side to the ninth node 137 and on the other side to ground. A fourteenth resistor 146 is electrically connected on one side to a negative input voltage VCC_N and on the other side to the ninth node 137. An output of the circuit is electrically connected to the ninth node 137. The output of the circuit provides an averaged voltage UM.

The eleventh resistor 130 may comprise, for example, 10Ω. The twelfth resistor 136 can comprise, for example, 5.6 kΩ. The thirteenth resistor 140 may comprise, for example, 3.3 kΩ. The fourteenth resistor 146 may comprise ve, for example, 10 Ml Ω. The sixth capacitor 144 may comprise a capacitance of 68 nF, for example.

FIG. 15 shows a diagram showing example pulse responses, integrated pulse responses, and averaged pulse responses.

FIG. 15 illustrates the detection of pulse height levels with an autonomous voltage controlled threshold.

In particular, the diagram shows an upper curve representative of input pulses that are offset voltage such that their maxima lie in the linear region near ground. The lower curve, which oscillates between about −10 mV and about 60 mV, represents an output signal of the circuit for detecting and measuring the pulse height of the signal and corresponds to an integral over the upper curve.

By summing, in particular integrating, the pulses on the sixth capacitor 144 with a time constant RC conditioned by the fourteenth resistor 146, the temporal noise component is collected only during the duration of the pulses, but not outside the duration of the pulses. This has the advantage of repressing systematic contributions of noise outside the duration of the pulses, which can also be referred to as “gated measurement”.

Due to the feedback to the input stage, the detected pulse height variations are used to adjust a discrimination threshold to reject a signal at the input that is not suitable for the expected pulse height range. In subsequent filtering stages, the detected pulse height variations can be addition-ally smoothed in the RC stage to monitor the obtained pulse height aggregation to any required degree of smoothing. A corresponding curve is shown in the lower part of the diagram and oscillates between about 10 mV and about 20 mV.

As explained in the foregoing, a voltage-controlled analysis of the pulse height of a signal can be performed by detecting the maximum in the substantially linear range with the least deviation of the amplifier 42, for example near zero volts (ground). To ensure particularly suitable operation, a closed feedback loop may be arranged prior to regulating the average values of the detected aggregated pulses near a predetermined set value, such as near zero volts, zero volts being the set controller value. For example, the closed feedback loop may have a PI controller that shows no residual control error and that has time constant settings for reliable loop stabilization.

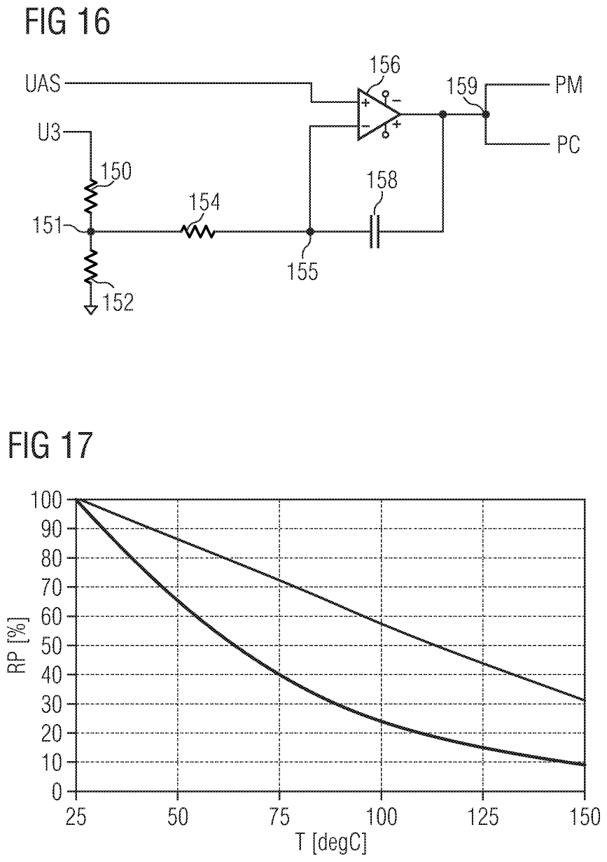

FIG. 16 shows an embodiment of a controller for adjusting a pulse height, where the controller can, for example, form the closed feedback loop and/or a PID controller. A smoothed output signal UAS is applied to an input of the controller, for example. The smoothed output voltage UAS may correspond to the averaged voltage PM of FIG. 14. Accordingly, the circuit shown in FIG. 14 may be connected upstream of the controller.

The output signal PC is fed to the input voltage VCC_P at the sixth resistor 86 of the main pulse height amplifier, forming a closed control loop and always controlling the pulse height peak to the same setpoint.

A third voltage U3 is applied to one end of a fifteenth resistor 150, which is electrically connected at its other end to a twelfth node 151, and a sixteenth resistor 152 is electrically connected on the one hand to the twelfth node 151 and on the other hand to ground, the set point being predetermined by the ratio of the fifteenth resistor 150 to the sixteenth resistor 152, for example to about +10 mV=about 0 V. A positive input (V+) of a fifth comparator 156 is electrically connected to the input of the controller. A negative input (V−) of the fifth comparator 156 is electrically connected to a thirteenth node 155. A seventeenth resistor 154 is electrically connected to the twelfth node 151 on one side and to a thirteenth node 155 on the other side. A seventh capacitor 158 is electrically connected on one side to the thirteenth node 155 and on the other side to a fourteenth node 159, to which an output of the fifth comparator 156 is also electrically connected. The seventeenth resistor 154 and the seventh capacitor 158 define the controller speed, the time constant of the PI controller, control dynamics characteristics (if the controller is too fast, the control loop may oscillate), etc.

The seventh capacitor 158 may comprise a capacitance of 100 μF, for example. The fifteenth resistor 150 may comprise, for example, 10 kΩ. The sixteenth resistor 152 may comprise, for example, 100Ω. The seventeenth resistor 154 may comprise, for example, 100 kΩ.

The fourteenth node 159 carries as the output of the fifth comparator 156 the current controller manipulated variable, which also carries the information about the current pulse height and thus the information about the current CO₂ content in the environment. In other words, the fourteenth node 159 carries as an output of the fifth comparator 156 the measurement signal of the current pulse height as a static measurement signal, which can now be supplied via the signal line PC to a pulse height monitor or display as a display value.

The feedback of the regulator manipulated variable is not shown in one figure alone. Rather, the feedback of the regulator manipulated variable originates in FIG. 16 with the pulse height control PC and flows into the main pulse height amplifier in FIG. 12 as a positive input voltage VCC_P.

The current regulator manipulated variable of the fifth comparator 156 is also fed back to the main pulse height amplifier via the input voltage VCC_P at the sixth resistor 86 to adjust the relevant offset bias voltage to maintain the pulse height at the output at its target point, as specified with the set value of the regulator. The selection of the sixth resistor 86 at the input of the main pulse height amplifier or at the output of the regulator 156 can be used to adjust the voltage level of the regulator. The resistance of the sixth resistor 86 may be, for example, 100 KS).

Since the information contained in the measured current pulses was removed by regulating the pulse heights to a fixed operating point, the corresponding information of the current signal was transferred to the output of the controller, where the corresponding output signal of the controller can be used to monitor the pulse height of the current pulses.

It is known that the emission of a light emitting device, for example an LED or an OLED, has a strong temperature dependence under given operating conditions. Since the measuring principle of the sensor arrangement is based on evaluating the received optical energy of the emissions of the optoelectronic device, the emission due to changes in ambient temperature overlaps the measurement results.

FIG. 17 shows a diagram illustrating an exemplary temperature dependence of a light source, in particular the temperature dependence of the emission energy on a temperature of the junction of a corresponding LED. From FIG. 17 it can be seen that even small changes in the temperature of the junction layer lead to changes in the emission energy in the percentage range, which directly overlaps the results of the absorption analysis in the per mil range. In order to appropriately correct the result of the light absorption analysis with respect to the temperature dependence, a precise measurement of the temperature can be performed.

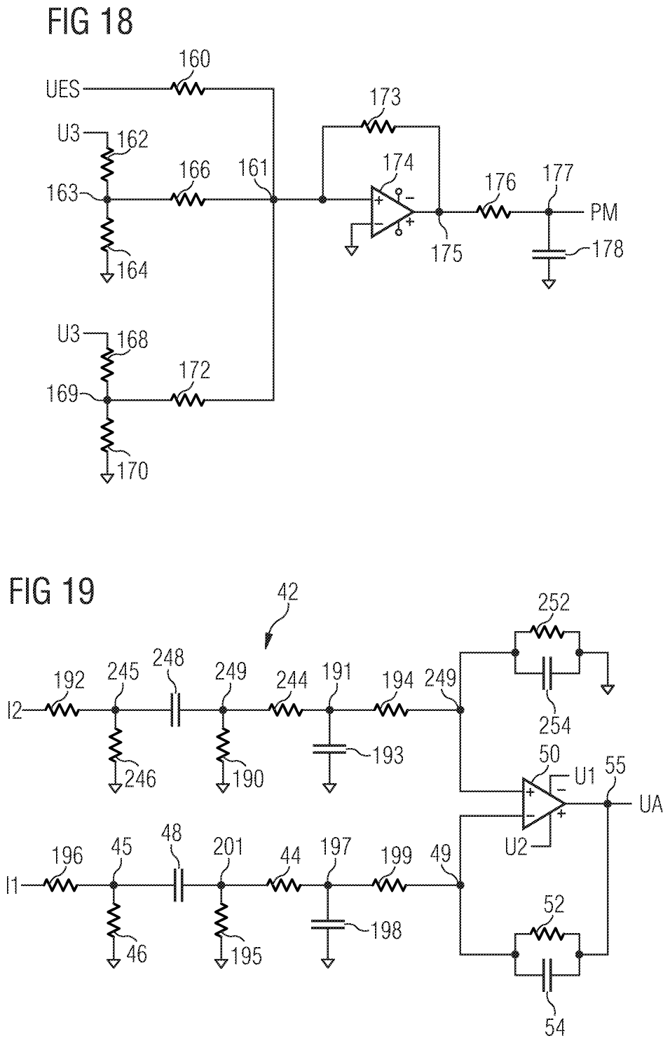

FIG. 18 shows an embodiment of a circuit for correcting a temperature dependence of the emission energy, for example, of the light source 40 and/or the reference light source 240, on the ambient temperature.

A smoothed input voltage UES is applied to an input of the circuit. The input voltage UES can be, for example, the pulse height monitor signal PM or the pulse height control PC.

The smoothed input voltage UES can correspond to the pulse height monitor signal PM. The smoothed input voltage UES carries the CO₂ information and is thus the CO₂ measurement signal from the measurement amplifier, which is not yet fully temperature-corrected and is to be fully temperature-corrected in this circuit with the aid of a measurement with a hot conductor, in other words with an NTC resistor, which can also be referred to as an NTC measurement.

A nineteenth resistor 160 is electrically connected to the input of the circuit on one side and to a fifteenth node 161 on the other side. On one side of a twentieth resistor 162, the third voltage U3 is applied and on another side of the twentieth resistor 162, the twentieth resistor 162 is electrically connected to a sixteenth node 163. The third voltage U3 may be 5 V, for example. A twenty-first resistor 164 is electrically connected to the sixteenth node 163 on one side and to ground on the other side. A twenty-second resistor 166 is electrically connected on one side to the sixteenth node 163 and on the other side to the fifteenth node 161. On one side of a twenty-third resistor 168, the third voltage U3 is applied and on another side of the twenty-third resistor 168, the twenty-third resistor 168 is electrically connected to a seventeenth node 169. A twenty-fourth resistor 170 is electrically connected to the seventeenth node 169 on one side and to ground on the other side. A twenty-fifth resistor 172 is electrically connected to the seventeenth node 169 on one side and to the fifteenth node 161 on the other side. A twenty-sixth resistor 173 is electrically connected on one side to the fifteenth node 161 and on the other side to an eighteenth node 175. A negative input (V−) of a sixth comparator 174 is electrically connected to the fifteenth node 161, a positive input (V+) of the sixth comparator 174 is electrically connected to ground, and an output of the sixth comparator 174 is electrically connected to the eighteenth node 175. A twenty-seventh resistor 176 is electrically connected to the eighteenth node 175 on one side and to a nineteenth node 177 on the other side. An eighth capacitor 178 is electrically connected to the nineteenth node 177 on one side and to ground on the other side. For example, a capacitance of the eighth capacitor 178 may be 1 μF.

The pulse height monitor signal PM may be tapped at the nineteenth node 177, wherein the pulse height monitor signal PM is temperature corrected as an output signal of the circuit and may be routed to the pulse height monitor PM.

The nineteenth resistor 160 may comprise, for example, 10 kΩ. The twentieth resistor 162 may be an NTC and have, for example, 47 kΩ. The twenty-first resistor 164 may comprise, for example, 47 kΩ. The twenty-second resistor 166 may comprise, for example, 33 kΩ. The twenty-third resistor 168 may comprise, for example, 10 kΩ. The twenty-fourth resistor 170 may comprise, for example, 10 kΩ. The twenty-fifth resistor 172 may comprise, for example, 10 kΩ. The twenty-sixth resistor 173 may comprise, for example, 1 MΩ. The twenty-seventh resistor 176 may comprise, for example, 1 kΩ. The eighth capacitor 178 may comprise a capacitance of 1 μF, for example. Since NTC resistors are inherently non-linear over the temperature range, an objective temperature measurement requires a linearization network to read out the temperature value, which is implemented by the circuit explained above in FIG. 18. Alternatively, the measurement signal carrying the CO₂ information can be input to a microcontroller that comprises a corresponding lookup table or formula for determining the temperature.

In total, three quantities are added and multiplied in the circuit explained above, and in particular is

PM=(U_PM in +k*U_NTC*Uconst)*v

where v=10 to 100 is virtually a postamplification for the measurement signal.

In the operation of the circuit for correcting the temperature dependence, the temperature is detected by the twentieth resistor 162, which may be located near the light source 24, 224. The circuit for linearizing the NTC measurement is a voltage divider with suitably tuned resistor values. The onion characteristic of a voltage divider would largely compensate for the anti-onion characteristic of an NTC.

The deviation of the measurement results of the sensor arrangement as a function of temperature can be critical, since the emission energy of the optoelectronic component can change with temperature in the percentage range, while the expected change in the signal due to the absorption of CO₂ is in the per mille range. The temperature dependence of the measurement results of the sensor arrangement can alternatively be reduced by performing a comparison measurement along the reference absorption path 230.

This complementary measurement allows for compensation of the temperature dependence of the measurement result due to the temperature of the light source 224 and the detecting light detector 240, and allows for an improvement in the precision of the measurement due to the paired comparison. In other words, this means that by using a second sensing cell, one can obtain a comparison reference that is subject to the same temperature effects as the actual sensing cell. As a result, the temperature behavior can be largely compensated for in the comparison measurement with this reference measurement, which can also be referred to as a paired comparison. A corresponding sensor arrangement is shown in FIG. 2, for example.

If there is still a temperature influence in the cleaned measurement signal, this could be cleaned up with the circuit described below.

FIG. 19 shows an embodiment of an amplifier, for example the amplifier 42. The amplifier 42 can be used, for example, as an alternative of the amplifier 42 explained with reference to FIG. 3 in the sensor arrangement with the absorption section 30 and the reference absorption section 230. In addition to the components explained with reference to FIG. 3, the amplifier 42 comprises the following components.

The second current I2 flows through a thirty-second resistor 192 which is electrically connected to the twentieth node 245. A thirty-first resistor 190 is electrically connected to the twenty-first node 249 on one side and to ground on the other side. In this embodiment, the twenty-eighth resistor 244 is electrically connected to the twenty-first node 249 on one side and to a twenty-second node 191 on the other side. An eleventh capacitor 193 is electrically connected to the twenty-second node 191 on one side and to ground on the other side. A thirty-third resistor 194 is electrically connected to the twenty-second node 191 on one side and to the twenty-first node 249 on the other side.

In this embodiment example, the first current I1 flows through a thirty-fifth resistor 196 which is electrically connected to the first node 45. A thirty-fourth resistor 195 is electrically connected to ground on one side and to a fourth node 201 on the other side. In this embodiment, the first resistor 44 is electrically connected to the fourth node 201 on one side and to a twenty-third node 197 on the other side. A twelfth capacitor 198 is electrically connected on one side to ground and on the other side to the twenty-third node 197. A thirty-sixth resistor 199 is electrically connected on the one hand to the twenty-third node 197 and on the other hand to the second node 49.

The eleventh capacitor 193 may comprise a capacitance of 100 nF, for example. The twelfth capacitor 198 may comprise a capacitance of 100 nF, for example. The thirty-first resistor 190 may comprise, for example, 10 MΩ. The thirty-fourth resistor 195 may comprise, for example, 10 MΩ. The thirty-second resistor 192 may comprise, for example, 10Ω. The thirty-fifth resistor 196 may comprise, for example, 10Ω. The thirty-third resistor 194 may comprise, for example, 1 kΩ. The thirty-sixth resistor 199 may comprise, for example, 1 kΩ.

Resistors whose electrical resistance is in the low ohm range are arranged at both inputs of amplifier 42 to adjust the photocurrent from both absorption paths 30, 230 if they have slight differences in their response.

Such differences may result from the fact that the absorption section under reference section is basically not identical. They may be formed by the same components, but in practice even the same components may have slightly different responses to the same excitation. The differences are incomparably greater if the same components are not used.

However, the thirty-second resistor 192 and the thirty-fifth resistor 196 enable the balance between the measuring section and the reference section to be established and the aforementioned differences to be compensated for by selectively choosing their electrical resistances from 1Ω to 100Ω in each case. The measurement signal of the absorption section may always be a little larger than that of the reference section so that the difference signal always remains in the positive range. Alternatively, it would also be possible to measure the pulse height in the negative direction for pulse height measurement.

High precision amplifiers with low leakage current are relatively expensive. In contrast, transimpedance amplifiers using dedicated separate low noise field effect transistors with low gate leakage currents and low gate capacitances are relatively low cost alternatives. Embodiments of corresponding amplifiers 42 are explained with reference to the following figures.

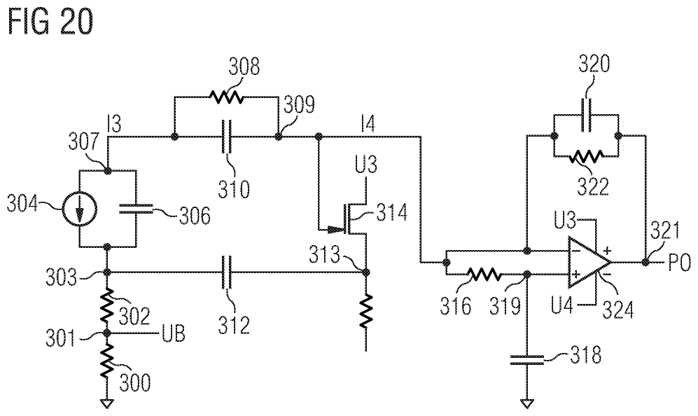

FIG. 20 shows an embodiment of a circuit for increasing a sensitivity of a sensor arrangement. A twenty-seventh resistor 300 is electrically connected to ground on one side and to a twenty-fourth node 301 on the other side. A bias voltage UB is applied to the twenty-fourth node 301. A thirty-eighth resistor 302 is connected on one side to the twenty-fourth node 301 and on the other side to a twenty-fifth node 303. A photodiode 304 is electrically connected on one side to the twenty-fifth node 303 and on the other side to a twenty-sixth node 307. A thirteenth capacitor 306 is electrically connected to the twenty-fifth node 303 on one side and to the twenty-sixth node 307 on the other side. A thirty-ninth resistor 308 is electrically connected on one side to the twenty-sixth node 307 and on the other side to a twenty-seventh node 309. A fourteenth capacitor 310 is electrically connected on one side to the twenty-sixth node 307 and on the other side to the twenty-seventh node 309. A third current I3 flows through the twenty-sixth node 307. A fifteenth capacitor 312 is electrically connected on one side to the twenty-fifth node 303 and on the other side to the twenty-eighth node 313. A first transistor 314 is electrically connected on one side to the twenty-eighth node 313 and on the other side to the twenty-seventh node 309. A third voltage U3 is applied to a drain of the first transistor 314. A fortieth resistor 316 is electrically connected on the one hand to the twenty-seventh node 309 and on the other hand to a twenty-ninth node 319. A fourth current I4 flows across the twenty-seventh node 309. A sixteenth capacitor 318 is electrically connected on one side to the twenty-ninth node 319 and on the other side to ground. A sixteenth capacitor 320 is electrically connected to the twenty-seventh node 309 on one side and to a thirtieth node 321 on the other side. A forty-first resistor 322 is electrically connected on one side to the twenty-seventh node 309 and on the other side to the thirtieth node 321. A negative input (−) of a seventh comparator 124 is electrically connected to the twenty-seventh node 309. A positive input (+) of the seventh comparator 124 is electrically connected to the twenty-ninth node 319. An output of the comparator 324 is electrically connected to the thirtieth node 321. In addition, a positive voltage input of the seventh comparator 324 may have the third voltage U3 applied thereto. A fourth voltage U4 may be present at a negative voltage input of the seventh comparator 124. A pulse output PO of the circuit is electrically connected to the thirtieth node 321.

For example, the thirteenth capacitor 306 may comprise a capacitance of 1 nF. The fourteenth capacitor 310 may comprise a capacitance of 100 pF, for example. The fifteenth capacitor 312 may comprise a capacitance of 100 μF, for example. The sixteenth capacitor 318 may comprise a capacitance of 100 nF, for example. The thirty-eighth resistor 302 may comprise, for example, 5 kΩ. The thirty-ninth resistor 308 may comprise, for example, 1 MΩ. The fortieth resistor 316 may comprise, for example, 1 MΩ. The forty-first resistor 322 may comprise, for example, 1 MΩ.

The circuit allows for an increase in the sensitivity of the sensor arrangement due to the use of the first transistor 314, which may be, for example, a field effect transistor. The first transistor 314 may, for example, cancel the capacitance of the internal pn junction of the photodiode, thereby improving the signal to noise ratio at the output of the amplifier 42. For example, the capacitance of the internal pn junction of the photodiode may be 1000 pF.

Bootstrapping can minimize the contribution of capacitive noise from the photodiode (as the sensing element). The output of the field-effect transistor-based bootstrapping stage can also be fed to any other amplifier circuit, which can also be referred to as bootstrapping with FET input.

For example, the circuit shown in FIG. 20 may be connected upstream of the amplifier 42 as an input stage in the sensor arrangement 20 shown in FIG. 2. The circuit shown in FIG. 20 can, for example, be connected upstream of the amplifier 42, in particular the twenty-eighth resistor 244, as an input stage in the sensor arrangement 200 shown in FIG. 3. The circuit shown in FIG. 20 can, for example, be connected upstream of the amplifier 42, in particular the first resistor 44, as an input stage in the sensor arrangement 200 shown in FIG. 3.

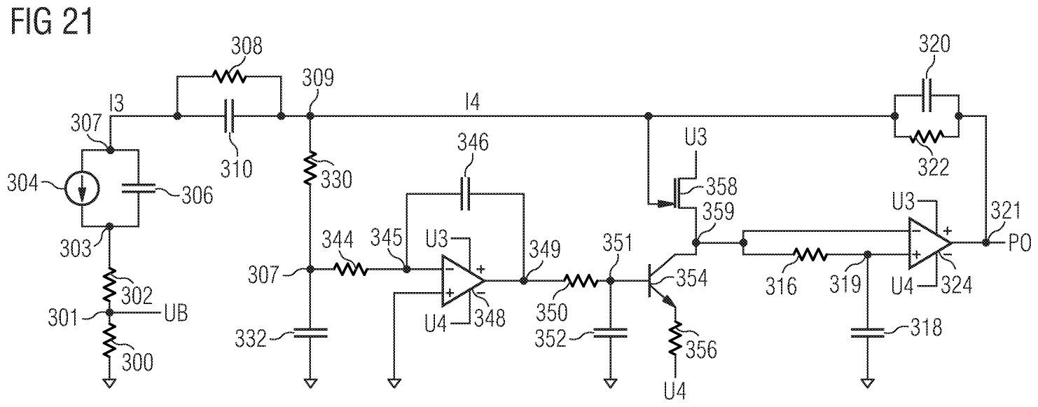

FIG. 21 shows an example of a circuit for increasing the sensitivity of a sensor arrangement. The circuit shown in FIG. 21 corresponds at least in part to the circuit explained with reference to FIG. 20, which is why only the components that are new compared to FIG. 20 are described below.

For example, the circuit shown in FIG. 21 can be connected upstream of the amplifier 42 as an input stage in the sensor arrangement 20 shown in FIG. 2. The circuit shown in FIG. 21 can, for example, be connected upstream of the amplifier 42, in particular the twenty-eighth resistor 244, as an input stage in the sensor arrangement 200 shown in FIG. 3. The circuit shown in FIG. 21 can, for example, be connected upstream of the amplifier 42, in particular the first resistor 44, as an input stage in the sensor arrangement 200 shown in FIG. 3.

A fourth resistor 330 is electrically connected to the twenty-seventh node 309 on one side and to the twenty-sixth node 307 on the other side. A nineteenth capacitor 332 is electrically connected on one side to the sixth twentieth node 307 and on the other side to ground. A forty-second resistor 344 is electrically connected to the twenty-sixth node 307, on the one hand, and to a sixth node 345, on the other hand. A twentieth capacitor 346 is electrically connected on one side to the sixth node 245 and on the other side to a thirty-first node 349. A negative input of an eighth comparator 348 is electrically connected to the sixth node 345. A positive input of the eighth comparator 348 is electrically connected to ground. An output of the comparator 348 is electrically connected to the thirty-first node 349. A third voltage U3 is applied to a positive voltage input of the eighth comparator 348. A fourth voltage U4 is applied to a negative voltage input of the eighth comparator 348. A forty-third resistor 350 is electrically connected to the thirty-first node 349, on the one hand, and to a thirty-second node 351, on the other hand. A twenty-first capacitor 352 is electrically connected to the thirty-second node 351 on one side and to ground on the other side. A base of a second transistor 354 is electrically connected to the thirty-second node 351. An emitter of the second transistor 354 is electrically connected to a twenty-fourth resistor 356. The forty-fourth resistor 356 is electrically connected to the emitter of the second transistor 354, on the one hand, and to the fourth voltage U4, on the other hand. A collector of the second transistor 354 is electrically connected to a thirty-third node 359. A base of a third transistor 358 is electrically connected to a twenty-seventh node 309. A third voltage U3 is applied to a drain of the third transistor 358. A source of the third transistor 358 is electrically connected to the thirty-third node 359. Further, the thirty-third node 359 is electrically connected to the fortieth resistor 316 and to the negative input of the seventh comparator 324.

The fourth resistor 330 may comprise, for example, 10 MΩ. The nineteenth capacitor 332 may comprise a capacitance of 100 nF, for example. The forty-second resistor 344 may comprise, for example, 1 kΩ. The twentieth capacitor 346 may comprise a capacitance of 1 nF, for example. The forty-third resistor 350 may comprise, for example, 10 kΩ. The twenty-first capacitor 352 may comprise a capacitance of 1 μF, for example. The forty-fourth resistor 356 may comprise, for example, 1 kΩ.

The circuit exhibits particularly high sensitivity due to the use of a separate low-noise field-effect transistor amplifier, comprising the first transistor 314 (in FIG. 20) and the third transistor 358 (in FIG. 21), respectively, as a direct current buffer for a low-quality monolithic amplifier input.

A closed-loop PI control loop is implemented by the eighth comparator 348. This PI control loop automatically adjusts an operating point of the transistor-based preamplifier on the premise that the average voltage across the gate of the preamplifier transistor is maintained at zero volts (zero-gating). Zero-gating can minimize the contribution of erroneous leakage currents from the photodiode (as the sensing element).

A particularly stable drive current for operating the light source 24, 224 can contribute to particularly precise absorption measurements in CO₂ detection. Variations in the drive current are directly superimposed on the measurement signal, which is why the drive current should be precisely regulated and stabilized with reference to environmental influences such as temperature and/or age.

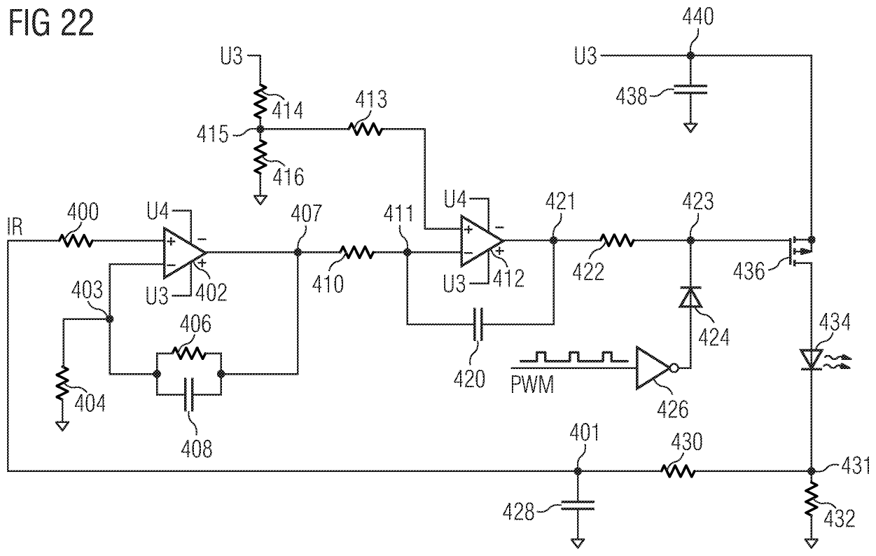

FIG. 20 and FIG. 22 show two different aspects of the circuitry of an FET preamplifier. FIG. 20 shows the so-called bootstrapping, where the active part of the photodiode capacitance can be reduced by a positive feedback to the sensor/photodiode. The capacitive noise of the photodiode can be compensated. FIG. 21 is a so-called zero-gating, where the voltage potential at the FET input is always exactly zero on average, which reduces faulty leakage currents from the sensor, also referred to as zero-gate control.

FIG. 22 shows an embodiment of a circuit for controlling a drive current, in particular for LED pulse operation. In particular, the circuit is used to provide a stable drive current for operating the light source 22, 222.

A forty-fifth resistor 400 is electrically connected to a positive input of a ninth comparator 402, on the one hand, and to a seventh node 401, on the other hand. A negative input of the ninth comparator 402 is electrically connected to a thirty-fourth node 403. A fourth voltage U4 is applied to a negative voltage input of the ninth comparator 402. A third voltage U3 is applied to a positive voltage input of the ninth comparator 402. A forty-sixth resistor 404 is electrically connected to the thirty-fourth node 403 on one side and to ground on the other side. A forty-seventh resistor 406 is electrically connected to the thirty-fourth node 403 on one side and to a thirty-fifth node 407 on the other side. A forty-second capacitor 408 is electrically connected on one side to the thirty-fourth node 403 and on the other side to the thirty-fifth node 407. An output of the ninth comparator 402 is electrically connected to the thirty-fifth node 407. A forty-eighth resistor 410 is electrically connected on one side to the thirty-fifth node 407 and on the other side to a thirty-sixth node 411. A tenth comparator 412 is electrically connected at its positive input to a twenty-ninth resistor 413, which is electrically connected on the other hand to a thirty-seventh node 415. The negative input of the tenth comparator 412 is electrically connected to the thirty-sixth node 411. An output of the tenth comparator 412 is electrically connected to a thirty-eighth node 421. A forty-ninth resistor 414 is electrically connected to a thirty-seventh node 415 on one side and is on the third voltage U3 on the other side. A fiftieth resistor 416 is electrically connected on one side to the thirty-seventh node 415 and on the other side to ground. A twenty-third capacitor 420 is electrically connected on one side to the thirty-sixth node 411 and on the other side to the thirty-eighth node 421. A thirty-second resistor 422 is electrically connected on one side to the thirty-eighth node 421 and on the other side to the thirty-ninth node 423. A third diode 424 is electrically connected on one side to the thirty-ninth node 423 and on the other side to an inverter 426. The inverter 426 inverts a pulse width modulated signal PWM. The pulse-width modulated signal PWM may be provided by an oscillator, for example. The pulse-width modulated signal PWM may be provided, for example, to a digital processing unit of the evaluation unit, if applicable. A twenty-fourth capacitor 428 is electrically connected to the seventh node 401 on one side and to ground on the other side. A thirty-third resistor 430 is electrically connected to the seventh node 401 on one side and to a fortieth node 431 on the other side. A thirty-fourth resistor 432 is electrically connected to the fortieth node 431 on one side and to ground on the other side. A light emitting diode 434, which may represent, for example, the light source 24, 224, is electrically connected on one side to the fortieth node 431 and on the other side to a drain of a fourth transistor 436. A gate of the fourth transistor 436 is electrically connected to a thirty-ninth node 423. A source of the fourth transistor 436 is electrically connected to a forty-first node 440. A third voltage U3 is applied to the forty-first node 440. A twenty-fifth capacitor 438 is electrically connected to the forty-first node 440 on one side and to ground on the other side.

The fifty-second resistor 430 may comprise, for example, 47 kΩ. The twenty-fourth capacitor 428 may comprise a capacitance of 100 nF, for example. The forty-fifth resistor 400 may comprise, for example, 1 kΩ. The forty-sixth resistor 404 may comprise, for example, 1 kΩ. The forty-second capacitor 408 may comprise a capacitance of 100 nF, for example. The forty-seventh resistor 406 may comprise, for example, 100 kΩ. The forty-eighth resistor 410 may comprise, for example, 10 kΩ. The twenty-third capacitor 420 may comprise a capacitance of 10 μF, for example. The fifty-first resistor 422 may comprise, for example, 2.7 kΩ. The forty-ninth resistor 414 may comprise, for example, 3.3 kΩ. The fiftieth resistor 416 may comprise, for example, 15 kΩ. The fifty-third resistor 432 may comprise, for example, between 0.01Ω to 10Ω, for example 1Ω. The fifty-third resistor 432 may be referred to as a current sensing resistor, or in other words a shunt, which is used to measure the actual current and is large enough to extract just enough measurement signal. For example, the twenty-fifth capacitor 438 may comprise a capacitance of 100 μF.

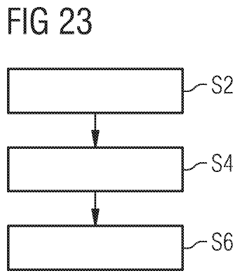

FIG. 23 shows a flowchart of an embodiment of a method for detecting CO₂ content in a given environment.

In the method, in a step S2, a light beam is generated by means of a light source, for example, the light beam 26 is generated by means of the light source 24.

In a step S4, the light beam after passing through an absorption path, for example the light beam 26 after passing through the absorption path 30, is detected by means of a light detector, for example the light detector 40. The absorption path has a length L in a range from 5 mm to 20 mm.

In a step S6, depending on an output signal of the light detector that is representative of a measured value that is representative of the absolute CO₂ content in the given environment, the absolute CO₂ content in the given environment is determined.

### REFERENCE LIST

20 first sensor arrangement
22 energy source
24 light source
26 light beam
30 absorption section
32 tubes
34 first end of the tube
36 second end of the tube
38 opening
40 light detector
42 amplifier
44 first resistance
45 node
46 second resistance
48 capacitor
49 second node
50 comparator
52 third resistance
54 second capacitor
55 node
60 first diagram
62 curve
70 first section
72 second section
74 third section
82 third capacitor
84 fifth resistance
86 sixth resistor
87 fifth node
88 seventh resistance
90 eighth resistance
92 ninth resistance
94 fourth capacitor
130 eleventh resistance
132 comparator
133 eighth node
134 diode
136 twelfth resistance
137 Ninth node
138 fourth comparator
139 tenth node
140 thirteenth resistance
141 first node
142 second diode
144 sixth capacitor
146 fourteenth resistance
150 fifteenth resistance
151 twelfth node
152 sixteenth resistance
154 seventeenth resistance
155 thirteenth node
156 fifth comparator
158 seventh capacitor
159 fourteenth node
160 nineteenth resistance
161 fifteenth node
162 twentieth resistance
163 sixteenth node
164 twenty-first resistance
166 twenty-second resistance
168 twenty third resistance
169 seventeenth node
170 twenty fourth resistance
172 twenty-fifth resistance
173 twenty-sixth resistance
174 sixth comparator
175 eighteenth node
176 twenty-seventh resistance
177 nineteenth node
178 eight capacitor
190 thirty-first resistance
191 twenty-second node
192 thirty-second resistance
193 eleventh capacitor
194 thirty third resistance
195 thirty-fourth resistance
196 thirty-fifth resistance
197 twenty-third node
198 twelfth capacitor
199 thirty-sixth resistance
200 second sensor arrangement
201 fourth node
222 reference energy source
224 reference light source
226 reference light beam
230 reference absorption section
232 reference tube
234 first end reference tube
236 second end reference tube
240 reference light detector
244 twenty-eighth resistance
245 twentieth node
246 twenty-ninth resistance
248 ninth capacitor
249 twenty-first node
252 thirty resistance
254 tenth capacitor
260 second diagram
262 fourth curve
300 thirty-seventh resistance
301 twenty fourth node
302 Thirty-eighth resistance
303 twenty-fifth node
304 photodiode
306 thirteenth capacitor
307 twenty sixth node
308 thirty nine resistance
309 twenty seventh node
310 fourteenth capacitor
312 fifteenth capacitor
313 twenty-eighth node
314 first transistor
316 fortieth resistance
318 sixteenth capacitor
319 twenty-ninth node
320 sixteenth capacitor
321 node
322 forty-first resistance
324 seventh comparator
330 resistance
332 nineteenth capacitor
344 forty-second resistance
345 sixth node
346 twentieth capacitor
348 eighth comparator
349 thirty-first node
350 forty third resistance
351 thirty-second node
352 twenty-first capacitor
354 second transistor
356 forty-fourth resistance
358 transistor
359 thirty third node
400 forty-fifth resistance
401 seventh node
402 ninth comparator
403 thirty-fourth node
404 forty-sixth resistance
406 forty-seventh resistance
407 thirty-fifth node
408 twenty-second capacitor
410 forty-eighth resistance
411 thirty-sixth node
412 tenth comparator
413 twenty-ninth resistance
414 forty-ninth resistance
415 thirty seventh node
416 fiftieth resistance
420 twenty third capacitor
421 thirty-eighth node
422 fifty-one resistance
423 thirty nine node
424 third diode
426 Inverter
428 twenty fourth capacitor
430 fifty-second resistance
431 fortieth node
432 fifty third resistance
434 Light emitting diode
436 fourth transistor
438 twenty-fifth capacitor
440 forty first node
L length
U1 first voltage
U2 second voltage
U3 third voltage
U4 fourth voltage
UA output voltage
UB bias
UE input voltage
UO offset voltage
UM averaged voltage
UAS smoothed output voltage
UES smoothed input voltage
PM pulse height monitor signal
PC pulse height control
PO pulse output
VCC_P positive input voltage
VCC_N negative input voltage
I1 first current
I2 second current
I3 third current
I4 fourth current
IR raw current
temperature
RP beam energy
PWM pulse width modulated signal
S2-S6 Steps one to three

1. A sensor arrangement for detecting a CO₂ content in a given environment, wherein the sensor arrangement comprises:
at least one controlled light source configured to generate a pulsed light beam;
an absorption path configured to communicate with the given environment, arranged such that the light beam passes through the absorption path;
a reference path sealed off from the given environment and arranged such that the light beam passes through the reference path;
a first light detector configured to detect the light beam emerging from the absorption path and configured to produce a first output signal representative of an absolute level of CO₂ in the given environment;
a second light detector configured to detect the light beam emerging from the reference path and adapted configured to generate a second output signal representative of a CO₂ content present in the reference path; and
an evaluation unit comprising an amplifier coupled on the input side to the first light detector and the second light detector and configured to provide an amplified difference signal from the first output signal and the second output signal at an output.

2. The sensor arrangement according to claim 1, wherein the reference path and the absorption path are thermally coupled to one another.

3. The sensor arrangement according to claim 1, wherein the absorption path comprises a tube open to the environment and having a cavity arranged such that the light beam enters the cavity at a first end of the tube and exits the cavity at a second end of the tube.

4. The sensor arrangement according to claim 1, wherein the reference path comprises a closed tube having a cavity and a CO₂ content predetermined therein, optionally including no carbon dioxide, arranged such that the light beam enters the cavity at a first end of the tube and exits the cavity at a second end of the tube.

5. The sensor arrangement according to claim 3, wherein the tube has a diameter between ranging from 3 mm to 6 mm.

6. The sensor arrangement according to claim 1, wherein the length of the absorption path and/or the reference path ranges from 8 mm to 15 mm.

7. The sensor arrangement according to claim 1, wherein the light of the light beam has a wavelength ranging from 4 μm to 5 μm.

8. The sensor arrangement according to claim 1, wherein the amplifier of the evaluation unit comprises a transimpedance amplifier configured to receive a current signal derived from the first output signal.

9. The sensor arrangement according to claim 1, wherein the amplifier is connected on the input side to a respective high-pass filter and is connected on the output side to a respective low-pass filter, which are designed to receive the first output signal and the second output signal, respectively.

10. The sensor arrangement according to claim 1, wherein the at least one controlled light source comprises a first light emitter and a second light emitter configured to generate a first pulsed light beam and a second pulsed light beam, the first light emitter and the second light emitter being thermally coupled to one another.

11. The sensor arrangement according to claim 1, further comprising a PWM circuit configured to generate a pulsed voltage signal or a current signal and connected to the controlled light source.

12. The sensor arrangement according to claim 1, wherein the evaluation unit comprises a microchip configured to
determine the absolute CO₂ content in the environment by comparing the output signal of the first light detector at the output of the absorption cell generated based on the light beam to the output signal of the second light detector generated based on the reference light beam.

13. A method for determining a CO₂ content in a given environment, wherein the method comprises:
generating a first pulsed light and a second pulsed light beam;
detecting the first light beam after passing through an absorption path communicating with the given environment and having a length ranging from 5 mm to 20 mm;
detecting the second light beam after passing through a reference path which is hermetically sealed from the given environment and has a constant predetermined CO₂ content and a length ranging from 5 mm to 20 mm; and
generating an output signal representative of the absolute CO₂ content in the specified environment based on a difference of the detected first light beam and the detected second light beam.

14. The method according to claim 13, further comprising determining a reference value based on the second detected light beam that is dependent on a length of the reference absorption path and the second light beam.

15. The method according to claim 13, wherein the detecting the first light beam and the second light beam comprises:
detecting a light after it has passed through the respective path;
generating a signal from the detected light; and
filtering the generated signal.

16. The method according to claim 14, wherein the reference value ranges from 50 mV to 150 mV.

17. The method according to claim 13, wherein a difference between a reference value derived from the second light beam and a measured value derived from the first light beam is positive.

18. The sensor arrangement according to claim 2, wherein the reference path and the absorption path are arranged on a common carrier, have a common side, or both.

19. The sensor arrangement according to claim 4, wherein the closed tube has no carbon dioxide therein.

20. The sensor arrangement according to claim 5, wherein the diameter ranges from 4 mm to 5 mm.
